(19) United States
(12) Patent Application Publication
(10) Pub. No.: US 2010/0004004 A1
(43) Pub. Date: Jan. 7, 2010

(54) System and Method for Matching User Preferences to Places of Interest

(76) Inventors: William Browne-Swinburne, Newcastle Upon Tyne (GB); Alexander Falfax, London (GB)

Correspondence Address: The Marbury Law Group, PLLC, 11800 SUNRISE VALLEY DRIVE, SUITE 1000, RESTON, VA, 20191, US

(21) Appl. No.: 12/166,350

(22) Filed: Jul. 2, 2008

(51) Int. Cl. H04W 4/02

(52) U.S. Cl. 455/457

(57) ABSTRACT

A system and method is provided for presenting points-of-interest (POI) content data on a mobile device. Software instructions are stored in the memory of the mobile device and are executed by the processor. The instructions enable the mobile device to display a list of POI categories for acceptance by a user. The category may be further divided into subcategories that are also displayed for user selection. The current position of the mobile device is requested from a location service provider or provided by the user. The current position and selected category and subcategory are formulated into a request for POI content data. The request is sent to selected POI content service providers whose service offerings include providing POI content data for the category/subcategory and current location. The POI content data received from the selected POI content service providers is displayed on the mobile device.

### BACKGROUND AND SUMMARY

Mobile communication devices are expensive to run, easy to lose, easily broken and communication may be spotty. Despite this, mobile communication has rapidly become a key means of communication for voice and data of all types for nearly 80% of the world's population. This is because mobile communication provides convenience, whether actual or perceived.

It is noteworthy that activities on mobile fall broadly into one of two categories: activity to save time, and activity to waste time. By far the strongest type of demand on mobile is the former, and clear evidence of this is in the global ubiquity of mobile voice communication for example. This traditional mobile activity has provided users with unparalleled convenience throughout the past 25-years and it is this same principal that is responsible for the overwhelming popularity of the medium.

A cell phone is a mobile communication device that operates within a physical area that is divided into cells. In order for cell service to work, the approximate location of a cell phone relative to a group of adjacent cells must be known. This attribute makes the cell phone suitable for receiving information relating a user's location to points-of-interest within a certain distance of the user. Other communication devices may be locatable by various means, including GPS and Bluetooth location schemes.

What would be useful is a system and method that advantageously uses the location capabilities of a mobile device to provide location-related content to the mobile device based on criteria entered by a user.

### DESCRIPTION OF THE DRAWINGS

FIG. 1 illustrates a flow of a graphical user interface from a user perspective according to an embodiment.

FIG. 2 illustrates an overall request process according to an embodiment.

FIG. 3 illustrates a search flow of a search engine performing an automated search according to an embodiment.

FIG. 4 illustrates the logical elements of an import service according to an embodiment hereof.

FIG. 5 illustrates a flow of a user subscribe flow according to an embodiment.

FIG. 6 illustrates a flow of a user subscribe flow according to an embodiment.

FIG. 7 illustrates possible subscription states and their relationships according to an embodiment.

FIG. 7 illustrates the logical elements of an import service according to an embodiment hereof.

FIG. 8 illustrates a block diagram of an architecture for hosting a content delivery service according to an embodiment.

### DETAILED DESCRIPTION

In the description that follows, reference is made to “points-of-interest.” As used in this description a point-of-interest may be a place, such as a restaurant, a park, a theater, a business address and a residential address, an event, such as an art exhibit or concert, or the location of another person. The event will also be associated with a location. Additionally, reference is made to a “postcode.” For purposes of this disclosure, a “postcode” is a code used to identify a geographic region serviced by a postal authority. Thus, a postcode includes, but is not limited to, a zip code. Reference is also made to a “geocode.” For the purposes of this disclosure, a “geocode” is a representational format of a geospatial coordinate measurement comprising at least a latitude and a longitude of a location. Reference is also made to a “location based service” or “LBS.” For the purposes of this disclosure, a LBS is a service that returns location data, which may be in the form of a postcode or geocode, that is indicative of a current location of a wireless mobile device.

The description that follows makes use of tables to illustrate embodiments. The values set forth these tables are considered exemplary and not limiting.

In an embodiment, a content delivery system (CDS) provides context-relevant information to users of wireless mobile devices. In one implementation, a CDS operator provides a mobile application that is installed and operated on a cell phone. In an embodiment, the mobile application is installed on the cell phone via a download. By way of illustration and not as a limitation, the mobile application may be downloaded to the cell phone through the following methods:
Voice-call to shortcode
SMS to shortcode
Direct from WAP site
Direct from Internet site
From phone to phone via Bluetooth
From phone to phone via SMS

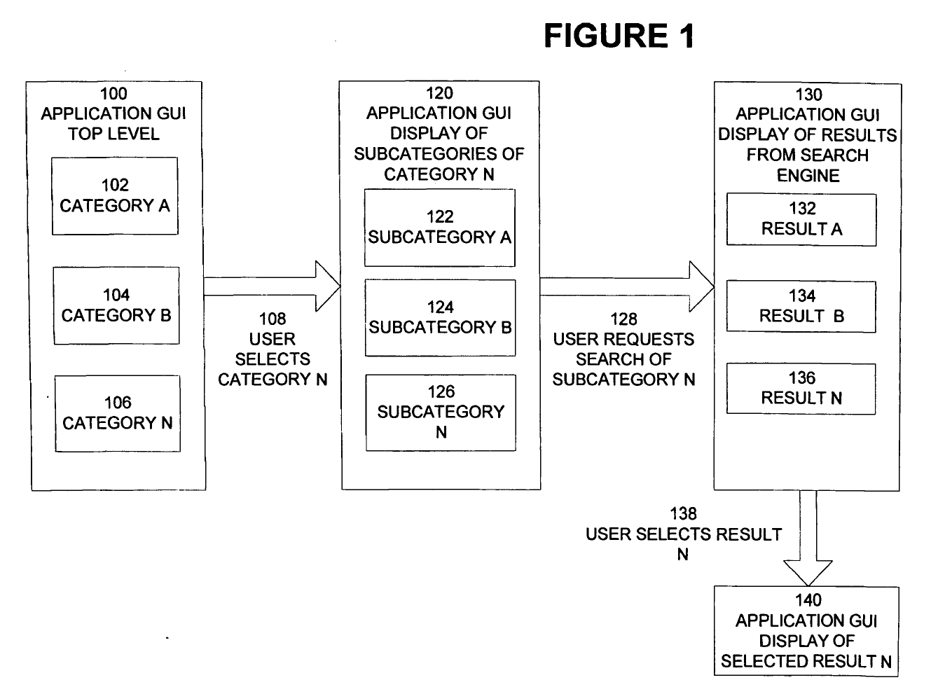

FIG. 1 illustrates a flow from a user perspective according to an embodiment. In an embodiment, the mobile application displays a graphical user interface (GUI) comprising a menu 100 of “categories” of points-of-interest (POIs). By way of illustration and not as a limitation, FIG. 1 illustrates category A 102, category B 104, and category N 106. By way of illustration and not as a limitation, a categories list may include bars, clubs, culture, film, social affinity groups of all kinds, hotels, health and fitness, pubs, and restaurants.

While the discussion that follows describes using a CDS to locate physical POIs, this description is illustrative only and not limiting. The CDS may be used to locate people who are users of the CDS. The functional elements of the CDS may also be applied to allow users of the CDS to meet other users that have common interests or needs.

The GUI is responsive to selection components of the cell phone. Thus, input components such as navigation keys, touch screens, and speech recognition systems normally assigned to navigate the cell phone features may be used to navigate the various lists and menus of the mobile application.

As illustrated in FIG. 1, a user selected category N 108.

A category may be further divided into subcategories. If so, the selection by the user of a category will prompt the mobile application to display a list of subcategories 120. By way of illustration and not as a limitation, FIG. 1 illustrates subcategory A 122, subcategory B 124, and subcategory N 126. The subcategories are also selectable by the user via the selection components.

By way of illustration and not as a limitation, the category “Food” may be further organized into subcategories Chinese, Italian, and Fast Food. As illustrated in FIG. 1, the user selects subcategory N and requests a search 128. On selection of a category or subcategory to search, the user's location is known and together with the time and selection, the most relevant results to those criteria are returned from one or more databases. A list of results is displayed by the GUI of the application 130. By way of illustration and not as a limitation, FIG. 1 illustrates result A 132, result B 134, and result N 126. The results are also selectable by the user via the selection components.

Upon selection of a result from the list, a “final” result is displayed. As illustrated in FIG. 1, the user selects result N 138 and the selected result is displayed 140. In an embodiment, the mobile application provides the user the option to share the final result with another party via Bluetooth, SMS or an IR connection. In an embodiment, the shared result comprises a link prompting the recipient to download the mobile application. The user is also given the option of submitting a new request or of exiting the mobile application.

The mobile application provides the user the option to share the results of the manual search with another party via Bluetooth, SMS or an IR connection.

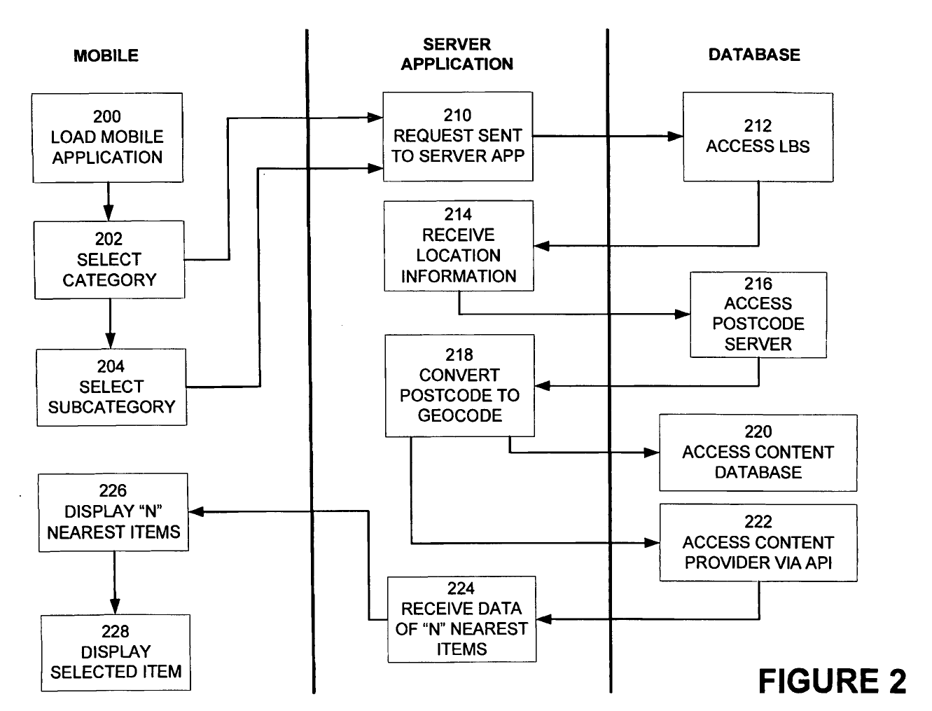

FIG. 2 illustrates an overall request process according to an embodiment. As illustrated in FIG. 2, the functions of a CDS are logically arranged according to whether the functions are to be performed by a mobile application running on a wireless mobile device, by a server application running on a server operated by (or for) a provider of an CDS, or by a database. While the functions of the server application and database are illustrated as to be logically distinct, it will be appreciated that some or all of these functions may be performed by a single physical device that comprises both the server application and the database logic.

A mobile application is loaded on a mobile device 200. A category is selected from a menu of POIs displayed by the mobile application 202. Optionally, a subcategory is selected from a menu of subcategories of the selected category 204. A request to search the category or subcategory is sent to a server application 210. In an embodiment, the server application runs on a server that is accessible to the wireless mobile device and that is operated by, or for, the operator of a CDS. The server application communicates with a database to access a location based service (LBS) 212. The LBS returns location data to the server application 214. In an embodiment, the location data may be a latitude and longitude or in the form of a postcode. As illustrated, the server application accesses a postcode server 216, which converts the postcode to a geocode and returns the geocode to the server application 218. Alternatively, the geocode can be use directly without any need for a determination of postcode.

The server application communicates the geocode to the database. A search engine operated by the server application accesses a content database 220 or a content provider 222 using the request criteria and the geocode and/or the location information. In an embodiment, the request criteria comprise the selected category and, if selected, the subcategory, and a radius value indicative of a distance from the location of the wireless mobile device to search for POIs that are assigned to the selected category and, if appropriate, subcategory.

The server application receives data associated with “N” nearest POIs within the selected category and, if appropriate, subcategory 224. The number of listed POIs “N” is arbitrary. However, in an embodiment, “N” is set to three. The “N” POIs are displayed by the mobile application for selection by the user 226. Following the user selection, information relating to the selected POI is displayed 228. By way of illustration and not as a limitation, the information relating to the selected comprises the name, address, telephone contact of the selected POI. Additionally, a map or illustrating a route to the selected POI may be displayed. The route map may be accompanied by text instructions detailing driving or walking directions to the POI. Further ancillary information, such as the availability of local transport, the location of an ATM, a rating of the selected POI, a general range of prices for goods and services offered by the POI, and a review of the POI may be provided. The user may call a POI directly from the mobile application or invite others to the meet at the POI via an “Invitation SMS.” In yet another embodiment, a user may also be presented with the opportunity to make a reservation at a hotel, a restaurant, or a performance near the POI. As an added incentive, the user may be offered a “discount” off the regular price charged by the POI or by businesses near the POI.

In order to manage traffic and number of requests without overburdening the server, and to allow for a maximum of users, a specific time may be set by the system operator for the duration of a search. Thus the server may receive a request and perform the requested search for a fixed period of time (e.g. 15 seconds) after which the results are returned to the user. In this way results are returned without an overly long search period. This timeout aspect is further discussed (below).

In an embodiment, the user elects to search manually. In this embodiment, the request further comprises location information provided by the user. If the user-provided location information does include a postcode, the request is sent to the server application 210 and the location information is forwarded to the database which then accesses a postcode server 216 (bypassing illustrated elements 212 and 214). If the user-provided location information includes a geocode, the request is sent to the server application 210 and the geocode and the request is forwarded to the database which then accesses either the content database 220 or the content provider 222 (bypassing illustrated elements 212, 214, 216, and 218).

In an embodiment, for both automated and manual searches, a determination is made whether the request for data is successful. If the data request is not successful, an error message is returned to the mobile application and displayed to the user. If the data request is successful, the user may then send the results to another person, exit the mobile application, or select a different result.

As illustrated in FIG. 2, the server application obtains the location information of the wireless mobile device from which a request is sent. In an embodiment, the location information is obtained via a location based service that associates a telephone number with longitude and latitude data and a radius about the coordinates in which the cell phone assigned the telephone number is located. In this embodiment, the location of a cell phone does not require or utilize GPS technology. However, this is not meant as a limitation. Other means, including the use of GPS technology, may be used to determine the location of the cell phone.

In an embodiment, the search engine component of the server application makes a determination whether the search request has produced results data. If not, the geographic area encompassed by the search as determined by the radius data is enlarged and the search engine again processes the request. If results data is returned, the user is billed and presented with the results data.

In an embodiment, the search engine is also implemented with a “thread pool” limit. The thread pool limit determines the number of instances of the search engine to be instantiated in response to the receipt of requests from users and determines the number of content providers that can be searched simultaneously.

Once the search engine has received the search criteria and the postcode, the search engine performs the following tasks:
A list of content providers is loaded and stored in cache.
A list of content providers is retrieved from the content provider cache based on a match between the requested postcode and category. In this way, only service providers that provide the desired content within the desired geographic location are searched.
In the event that there are no content providers available for the requested postcode and category, then additional content providers may be loaded into the search engine. Alternatively, national content providers may be searched. In yet another alternative, an error may be returned to the mobile application and displayed to the user.
If a set of content providers meeting the search criteria has been identified, then each member of the set of content providers is called via an agreed protocol in order to retrieve a list of locations. In an embodiment, an order in which these content providers are used is determined by a rank (described below) associated with the content provider.
When a set of points-of-interest has been returned for a set of content providers, the points-of-interest are ordered by the nearest to the location of the cell phone. For example, the top three distinct locations are displayed to the user of the wireless mobile device.
In the event that the request has exceeded an arbitrary timeout value, then the request will be terminated, and results (POIs) retrieved to that point will be returned to the user or, in the event that no POI's have been received, an error message will be returned.

In an embodiment, the mobile application interacts with a server application running on a server operated by or for the operator of a CDS. The server application the search engine comprises a set of configuration values. The configuration values determine the behavior of the CDS and provide the search engine information necessary to communicate with the content providers.

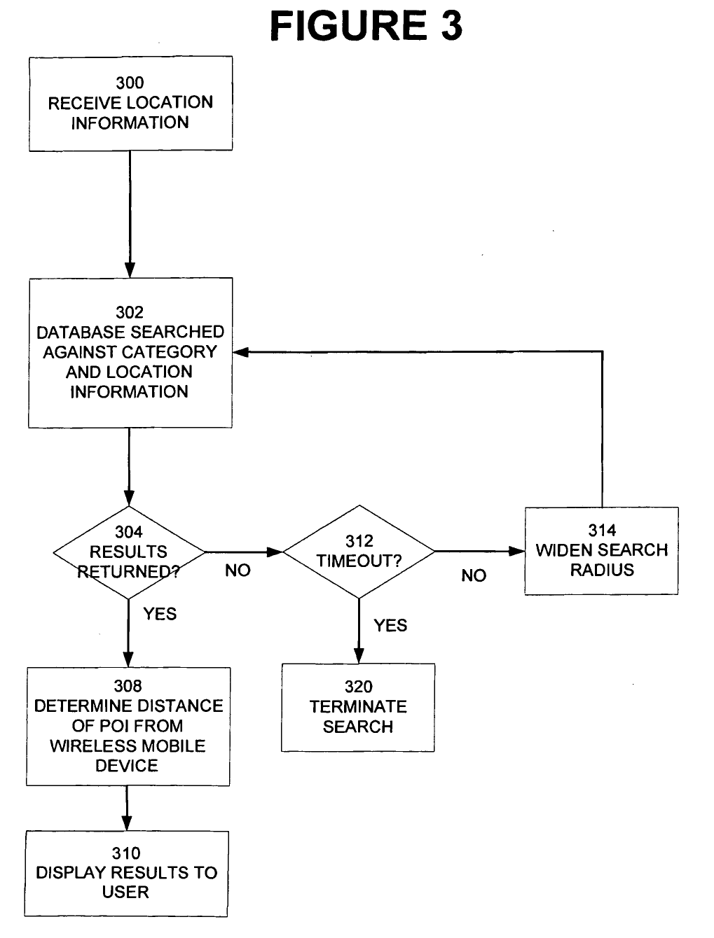

FIG. 3 illustrates a search flow of a search engine performing an automated search according to an embodiment. The search flow is illustrated from the point when the user has selected a category and an LBS lookup has been performed. In an embodiment, the World Geodetic System 1984 (WGS84) standard is used for GeoCode data which is in WGS84 Latitude and WGS84 Longitude. The latitude and longitude of the client's position can be determined from the location based service (using the WGS84 standard). However, this is not meant as a limitation. Other standards for determining location data may be used.

The search engine receives location data 300. A database is searched using the category (or subcategory) selected 302. As described below, the database may be a central database or a database operated by a content provider. The search engine retrieves POIs located within a specified area. A determination is made whether the results were returned or whether the number of results returned meets a preset number of results 304. If the number of results returned meets a preset number of results, a distance from the wireless device location to each POI is computed 308. The results are displayed to a user in order of increasing distance from the wireless device location 310.

If the search returns an insufficient number of locations, then a determination is made whether the search time has exceeded a present limit 312. If the search returns an insufficient number of locations and the search time has not been exceeded, the search radius is widened until preset number of results is returned 314. If the present timeout period has been exceeded, the search is terminated 320 and the POIs retrieved are sent to the client.

In an embodiment, the distance from a POI and a wireless mobile device is computed using an algorithm. By way of illustration, a kilometer is approximately 0.008999 degrees in latitude and 0.015299 degrees in longitude (the longitude is an average based on 1° longitude at 50° latitude=71.70 kms, and 1° longitude at 60° latitude=55.80 kms). To determine which locations are approximately within 1 km of the sthece (that is, north, south, east and west of the sthece, or within a 2 km² quadrant), then a location would only be valid if it met the following criteria:
If the search location latitude is greater than or equal to the sthece location latitude then the search location must not exceed the sthece location latitude+0.008999;
If the search location latitude is less than or equal to the sthece location latitude then the search location latitude must be greater than or equal to the sthece location latitude−0.008999.
If the search location longitude is greater than or equal to the sthece location longitude then the search location must not exceed the sthece location longitude+0.015299.
If the search location longitude is less than or equal to the sthece location longitude then the search location longitude must be greater than or equal to the sthece location longitude−0.015299.

Using this model, longitudinal values can be positive or negative. In order to ensure position longitudinal values, adjustment factors may be applied. By way of illustration and not as a limitation, values within the UK may be adjusted by −1.3 degrees and multiplied by −1 in order to provide a positive longitude value.

If a suitable set of locations were identified then the direct distance between the sthece location and each valid location would be calculated. This list would then be sorted according to distance, and the top three results returned to the client.

The distance calculation may be performed using known techniques. By way of illustration and not as a limitation, the determination may be made by applying Pythagoras Theorem. If distances involved are small and accuracy is not critical, this approach will produce good results. However, in large regions where the distances may be larger, determination of the distances between points may be more accurately determined using a formula that accounts for the curvature of the earth. One such formula is the Haversine formula.

A manual search mechanism works differently from the automated search flow (see, FIG. 3) in that the location to search against is entered as either a post code, town or city which is converted into geocodes before the search is performed.

The search engine may be configured to manage the behavior of the search engine. By way of illustration and not as a limitation, Table 1 illustrates the elements of a GUI configuration file of a search engine according to an embodiment.

TABLE 1

| Configuration POI | Type | Value | Description |
|---|---|---|---|
| Request Time Out | Int | >=0 | The maximum amount |
| | | <=20 | of time (seconds) the search |
| | | | engine has to process the client |
| | | | request. |
| Maximum Number of | Int | >=0 | The maximum number |
| Locations Returned to | | <=3 | of locations that are to |
| Client | | | be returned to the client. |
| StartSearchRadius | Int | >=0 | The radius at which to |
| | | | start the search from the |
| | | | client location (Kilometres) |
| MaximumSearchRadius | Int | <=10 | The radius at which to |
| | | | stop the search (Kilometres) |
| SearchRadiusIncrement | Int | >=1 | The value used to |
| | | <=10 | increase the search |
| | | | radius (Kilometres) |
| LongitudeOffset | Numeric(4, 2) | 1.3 | The value used to adjust |
| | | | all longitude values. |
| MinimumLatitude | Numeric(9, 6) | 50° | The minimum latitude |
| MaximumLatitude | Numeric(9, 6) | 57° | The maximum latitude. |
| MinimumLongitude | Numeric(9, 6) | −5.5° | The minimum longitude |
| MaximumLongitude | Numeric(9, 6) | 1.3° | The maximum |
| | | | longitude |
| Maximum Number of | Int | >=0 | The maximum number of |
| Locations | | <=500 | locations required before |
| | | | the search engine stops |
| | | | processing the content |
| | | | providers. |
| Maximum Number of | Int | >=1 | The maximum number of |
| Concurrent Searches Per | | <=10 | concurrent searches that are |
| Request | | | performed for each client |
| | | | request. That is, the number |
| | | | of content providers that |
| | | | are processed at the same |
| | | | time. |

The values set forth in Table 1 are considered exemplary and not limiting. The values established for the longitude offset, minimum and maximum latitude and minimum and maximum longitude are illustrative of a search engine configured for operation in the United Kingdom.

The search engine configuration information also identifies all the content providers that can be used by the search engine. Table 2 illustrates the content of a configuration file for a content provider known to the search engine according to an embodiment.

TABLE 2

| Field Name | Data Type | Notes |
|---|---|---|
| ContentProviderId | Int | Primary Key |
| Description | String(100) | |
| Company Name | String(200) | The name of the company supplying the content. |
| IntroducedOn | DateTime | The date the content provider was added to the |
| | | system. |
| IsNational | Boolean | TRUE - The content provider is used for national |
| | | searches. This will ignore the postal area and |
| | | category configuration. |
| | | FALSE - The search engine will use the postal area |
| | | and category configuration that has been defined. |
| RankId | Int | A measure of the performance of the content |
| | | provider. |
| Active | Boolean | TRUE - The search engine will use the content |
| | | provider. |
| | | FALSE - The search engine will not use the content |
| | | provider. |
| Logo | Byte(TBC) | Logo used by the content provider for displaying |
| | | within the mobile communication device mobile |
| | | application. This should be small, in order that it |
| | | does not impact performance when returning data to |
| | | the client. |

The content provider is identified by a unique “ContentProviderId.” A content provider is also identified as “national” or “local” using a Boolean operator. A national content provider provides information that is not grouped by postcodes or other location identifiers. If a content provider is identified as national, the search engine will disregard the postal area and category configuration information (each of which is described below).

The string sizes set forth in Table 2 are considered exemplary and not limiting.

In one embodiment, the proximity to the target always takes precedence over every other factor. However, where multiple content providers return the same location, the content providers are ranked in order of precedence and the data from the highest ranking content provider is used. The precedence thus determines when the content of one content provider is displayed over the content of another based on the results returned. The precedence may be determined based on financial considerations. For example, if content provider A signs a more lucrative license with the CDS operator than content provider B, the content of content provider A will be displayed more frequently than content provider B, thus offering A a greater opportunity to earn revenue.

Table 3 illustrates the content of a content provider ranking configuration file according to an embodiment.

TABLE 3

| Field Name | Data Type | Notes |
|---|---|---|
| ContentProviderID | Int | Primary Key |
| Precedence | Int | A value determining the precedence |
| | | inwhich content providers content |
| | | should be used. NOT NULL. |
| | | UNIQUE. |
| CreatedOn | DateTime | The date the record was created |
| ModifiedOn | DateTime | The date the record was last |
| | | modified |

The string size set forth in Table 3 is considered exemplary and not limiting.

To further illustrate the content of Table 3, Table 4 illustrates the possible rank identifiers and the values assigned to them according to an embodiment.

TABLE 4

| RankId | Description |
|---|---|
| 1 | Highest priority |
| 2 | decreasing priority |
| 3 | decreasing priority |
| 4 | decreasing priority |
| 5 | Lowest priority |

In another embodiment, a statistical model is used to select a content provider to return data in response to a request. In this embodiment, the performance of a service provider relative to an expected performance is monitored. The relative performances of all of the service providers able to provide a response to a request are then evaluated using an algorithm to select the actual provider. The information used by the algorithm is set forth in Tables 5-9 below.

Table 5 captures the details of licenses held by all content providers. It is assumed that a content provider will only have one license in any one period of time.

TABLE 5

| Field Name | Data Type | Notes |
|---|---|---|
| LicenseId | Int | Primary Key. |
| ContentProviderID | Int | Foreign Key |
| | | References ContentProvider.ContentProviderId |
| | | NOT NULL |
| LicenseAmount | Numeric(9, 2) | The amount of the license (pounds) for the |
| | | period. NOT NULL |
| LicenseStart | DateTime | The date the license starts. NOT NULL |
| LicenseEnd | DateTime | The date the license ends. LicenseEnd >= |
| | | LicenseStart NOT NULL |
| LicenseAmountPerDay | Numeric(9, 2) | The amount the license is worth for each day. |
| | | LicenseAmountPerDay = LicenseAmount/ |
| | | (LicenseEnd − LicenseStart)CALCULATED |
| | | NOT NULL |
| CreatedOn | DateTime | The date the record was created. NOT NULL |
| ModifiedOn | DateTime | The date the record was last modified |

Table 6 stores the number of locations returned for a period of time and for a content provider.

TABLE 6

| Field Name | Data Type | Notes |
|---|---|---|
| PeriodId | Int | Primary Key. |
| PeriodStart | DateTime | The start date of the period. NOT |
| | | NULL PeriodStart <= PeriodEnd |
| PeriodEnd | DateTime | The end date of the period. NOT NULL |
| | | PeriodEnd >= PeriodStart |
| TotalLocationsReturnedInPeriod | Int | The total number of locations returned |
| | | in this period of time by all content |
| | | providers. This value could be |
| | | incremented each time a client request |
| | | has been successfully fulfilled, or |
| | | processed on a daily basis NOT NULL. >= |
| | | zero |
| TotalLicenseRevenueForPeriod | Numeric(9, 2) | The total license revenue for the |
| | | period.Calculated by summing |
| | | Period.LicenseAmountPerDay for |
| | | everyday that occurs within the |
| | | PeriodStart andPeriodEnd. NOT |
| | | NULL. >= zero |
| CreatedOn | DateTime | The date the period was created |
| ModifiedOn | DateTime | The date the period was last modified |

In this embodiment, the PeriodStart/PeriodEnd combination does not overlap any existing record in this table and is contiguous. The actual period duration (PeriodEnd−PeriodStart) is arbitrary. In an embodiment, the period duration is in multiples of whole days.

Table 7 stores the number of locations returned for a period of time and for a content provider.

TABLE 7

| Field Name | Data Type | Notes |
|---|---|---|
| ContentProviderId | Int | Primary Key.Foreign Key |
| | | referencesContentProvider.ContentProviderId |
| PeriodId | Int | Primary Key. Foreign Key references |
| | | Period.PeriodId |
| TotalLocationsReturned | Int | The total number of locations returned in this |
| | | period for the specified content provider. This |
| | | value could be updated each time a location |
| | | is returned to the client when it occurs within |
| | | the PeriodId. PeriodStart and |
| | | PeriodId. PeriodEnd for the |
| | | specifiedContentProviderId, or pre-processed |
| | | on a daily basis. NOT NULL. >= zero |
| ActualPercentageOfTotal | Numeric(6, 3) | The actual percentage of total locations that |
| | | have been returned by this content provider in |
| | | this period of time. This value can be updated |
| | | when the TotalLocationsReturned value is |
| | | updated, or pre-processed on a daily basis. |
| | | This is calculated by dividing |
| | | the TotalLocationsReturned by |
| | | the TotalLocationsReturnedInPeriod value |
| | | stored in the Period table for the specified |
| | | PeriodId and then multiplyingby 100. NOT |
| | | NULL >= 0 <= 100 |
| RequiredPercentageOfTotal | Numeric(6, 3) | The required percentage of total locations |
| | | that should be returned by this content |
| | | provider in this period of time. This value is |
| | | calculated by dividing the content provider's |
| | | contribution for this period by the total |
| | | license fee for the period and then |
| | | multiplying by 100. NOT NULL >= 0 <= 100 |
| CreatedOn | DateTime | The date the content provider/period was |
| | | created |
| ModifiedOn | DateTime | The date the content provider/period was last |
| | | modified |

The following example illustrates the RequiredPercentageOfTotal value for a total revenue of $10,000 in the specified period of time Jun. 1, 2008-May 31, 2009 for a given set of content providers licensed for that period of time:

TABLE 8

| | | Required Percentage of Total |
|---|---|---|
| Content Provider | License Value | Locations |
| A | 5000 | 50 |
| B | 2500 | 25 |
| C | 2000 | 20 |
| D | 500 | 5 |

The values set forth in Table 8 are considered exemplary and not limiting.

In order to resolve which content provider returns locations to the client when the category and proximity are the same, the difference between the RequiredPercentageOfTotal and the ActualPercentageOfTotal is calculated. The content provider with the highest difference is chosen. In the highly unlikely event that more than one content provider had the same difference, the content provider would be selected randomly. Table 9 illustrates how content provider “C” is selected according to this algorithm:

TABLE 9

| | Required | | |
|---|---|---|---|
| | Percentage of | Actual | |
| Content | Total | Percentage of | |
| Provider | Locations | Total Locations | Difference48 |
| A | 50 | 48 | 2 |
| B | 25 | 20 | 5 |
| C | 20 | 13 | 7 |
| D | 5 | 2 | 3 |

The information in Tables 5-9 can be calculated in real time (which would provide a very accurate way of determining the correct content provider). In another embodiment, the table information is pre-processed on a daily basis in order to limit impact on the system.

As previously described and as illustrated in FIG. 2, the search engine may search a central database or a database operated by a content provider. The search engine is configured to perform these searches as described below.

The central database is populated with POI information provided by content providers. In order to fill the database, the data from a content provider is imported and transformed via a web service. In an embodiment, one web service serves all of the participating content providers. In another embodiment, a web service is provided per content provider. The location import schema allows content providers to supply locations to the operator of a CDS with a category of selected by the content provider. It is envisaged that this category would be translated with the corresponding CDS category before the location is transferred into the database. In an embodiment, verification of the address data is provided to ensure data integrity.

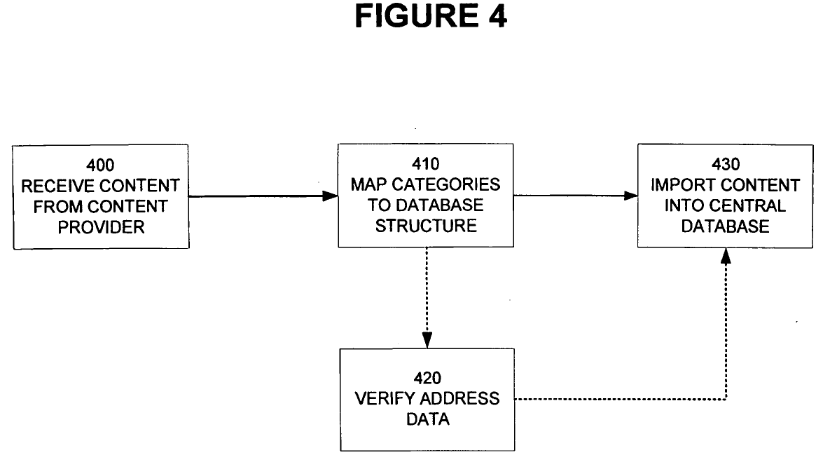

FIG. 4 illustrates the logical elements of an import service according to an embodiment hereof. Data from a content provider is received at a website 400. The content provider data is mapped to the structure of the central database 410 and imported into the central database 430. Optionally, the address data for POIs provided by the content provider are verified before importation into the central database 420.

In an embodiment, standards by which content providers provide content data are established. A “patching application” receives content submissions from content providers. By way of illustration and not as a limitation, the content submissions are obtained via FTP or a webservice. The patching application then transforms the data from the content provider and inserts it into the central database so that all the relevant relationships and tracking information are captured. This transformation utilizes a category mapping table and import logging table(s) for capturing import processing data.

Different content providers may identify categories using different terms. Table 10 illustrates the content of a category mapping configuration file according to an embodiment. This configuration file defines how the content provider maps categories to the system categories.

TABLE 10

| Field Name | Data Type | Notes |
|---|---|---|
| ContentProviderCategoryMappingId | Int | Primary Key |
| ContentProviderId | Int | |
| CategoryId | Int | |
| ProviderCategoryIdentifier | String(100) | TBC |

The ContentProviderId and CategoryId field combination will be unique.

The string size set forth in Table 10 is considered exemplary and not limiting.

In an embodiment, the patching application ensures the following when transferring data into the database:
There are no duplicate rows for the same POI (e.g., Restaurant) in the location table; and
When there is more than one content provider with the same content, one copy of the content is stored in the Location table with many to many relationships with the ContentProviderLocation table. Thus, one restaurant can be found in more than one content provider. For example, restaurant A may be in the AA and Squaremeal. So, rather than the restaurant details twice, one copy of the content is stored and the content is mapped to multiple content providers.

The mobile application also organizes the different categories from the content providers into normalized categories. For example, if a content provider has categories for Indian/Chinese/Korean and the mobile application had one category (Asian cuisine) for all the categories, then the data is reclassified before being stored into the database.

Table 11 illustrates the fields of a central database:

TABLE 11

| Field Name | Data Type | Notes |
|---|---|---|
| ContentProviderId | Int | The unique value used to |
| | | identify the content provider. |
| | | This value would be provided |
| | | by mobile application. |
| Name | String | The name of the establishment. |
| | | Max length (to be |
| | | confirmed) NOT NULL |
| AddressLine1 | String | Max length (to be |
| | | confirmed) NOT NULL |
| AddressLine2 | String | Max length (to be confirmed) |
| City | String | Max length (to be |
| | | confirmed) NOT NULL |
| Postcode | String | Max length (to be |
| | | confirmed) NOT NULL |
| TelephoneNumber | String | Max length (to be confirmed) |
| ItunesStyleStarRating | String | Max length (to be confirmed) |
| PriceGuide | String | Max length (to be confirmed) |
| Latitude | Numeric(9, | The latitude of the location |
| | 6) | using theWGS84 standard. E.g. |
| | | 50.083326. Min Value: |
| | | >=50.000000 |
| | | Max Value: |
| | | <=57.000000 NOT NULL |
| Longitude | Numeric(9, | The longitude of the location |
| | 6) | using theWGS84 standard. E.g. |
| | | −5.25. Min Value: >=−4.60 Max |
| | | Value: >=1.30 NOT NULL |
| Category | String | Max length (to be |
| | | confirmed). The category used |
| | | by the contentprovider. |

In an embodiment, a location table defines all the establishments that can be used by the search engine and ultimately returned to the client. In an embodiment, the table is configured such that every row in this table is unique for an entry with the same Company Name, AddressLine1 and Postcode. However, this is not meant as a limitation. Other table structures may be used to provide location information for points of interest. Table 12 illustrates a location table according to an embodiment:

TABLE 12

| Field Name | Data Type | Notes |
|---|---|---|
| LocationID | Int | Primary Key |
| Company Name | String | The name of the establishment. Max |
| | | length (to be confirmed) NOT NULL |
| AddressLine1 | String | Max length (to be confirmed) NOT NULL |
| AddressLine2 | String | Max length (to be confirmed) |
| City | String | Max length (to be confirmed) NOT NULL |
| Postcode | String | Max length (to be confirmed) NOT NULL |
| TelephoneNumber | String | Max length (to be confirmed) |
| ItunesStyleStarRating | String | Max length (to be confirmed) |
| PriceGuide | String | Max length (to be confirmed) |
| Latitude | Numeric(9, 6) | The latitude of the location using theWGS84 |
| | | standard. E.g. 50.083326. Min Value: >=50.000000 |
| | | Max Value: <=57.000000 NOT NULL |
| Longitude | Numeric(9, 6) | The longitude of the location using |
| | | theWGS84 standard. E.g. −5.25. Min |
| | | Value: >=−4.60 Max Value: >=1.30 |
| | | NOT NULL |
| PostAreaId | Int | Identifies the post area to which this |
| | | location belongs. Foreign Key |
| | | References PostArea.PostAreaId |
| | | NOT NULL |
| CategoryId | Int | Identifies the category to which this |
| | | location belongs. Foreign Key |
| | | References Category.CategoryId NOT NULL |
| CreatedOn | DateTime | The date the location was created. |
| | | NOT NULL |
| ModifiedOn | DateTime | The date the location was last modified. |
| IsActive | Boolean | Determines if the location can be used by the |
| | | search engine as valid content. NOT NULL |

The location search table defines all the information used by the search engine in order to provide content to the client. In an embodiment, only active locations that are associated with at least one active content provider are reflected in this table. In addition, the table may be optimized for quickly identifying suitable locations by the search engine. Table 13 illustrates a location search table according to an embodiment.

TABLE 13

| Field Name | Data Type | Notes |
|---|---|---|
| LocationID | Int | Primary Key. Foreign Key |
| | | references location. LocationID |
| | | NOT NULL. |
| Latitude | Numeric(9, | The latitude of the location using |
| | 6) | theWGS84 standard. E.g. |
| | | 50.083326. Min Value: >=50.000000 |
| | | Max Value: <=57.000000 |
| | | NOT NULL |
| Longitude | Numeric(9, | The longitude of the location using |
| | 6) | theWGS84 standard. E.g. −5.25. Min |
| | | Value: >=−4.60 Max Value: >=1.30 |
| | | NOT NULL |
| AdjustedLongitude | Numeric(9, | The adjusted longitudinal value. 1.3 |
| | 6) | is subtracted from the Longitude and |
| | | then multiplied by −1 in order to |
| | | speed up database searches. 1.3 |
| | | degrees EASTsignifies the most |
| | | easterly tip of the UK. NOT NULL |
| CategoryId | Int | Identifies the category to which this |
| | | location belongs. Foreign Key |
| | | References Category.CategoryId |
| | | NOT NULL |

A category is used to define a set of system categories that can be searched by the rules engine. Table 14 illustrates the content of a category configuration file according to an embodiment.

TABLE 14

| Field Name | Data Type | Notes |
|---|---|---|
| CategoryId | Int | Primary Key |
| ParentCategoryId | Int | NULLABLE. References |
| | | CategoryId |
| Description | String(100) | |
| Active | Boolean | TRUE - category can be used to |
| | | search on. |
| | | FALSE - category can not be used |
| | | to search on. |

The string size set forth in Table 14 is considered exemplary and not limiting.

To further illustrate the content of Table 14, Table 15 illustrates the content of an exemplary category configuration file according to an embodiment:

TABLE 15

| Category ID | Description | Category Id | Active |
|---|---|---|---|
| 1 | Pubs | NULL | True |
| 2 | Restaurants | NULL | True |
| 3 | Clubs | NULL | True |
| 4 | Florists | NULL | True |
| 5 | Chinese | 2 | True |
| 6 | Indian | 2 | True |

In an embodiment, a region table is used to categorize post areas. For example, LS, BD, WF all belong to West Yorkshire. So, if Yorkshire Post was only licensed to serve content in Yorkshire, if the user was in Lancashire, then they would not be served data from Yorkshire Post's content database. Table 16 illustrates the contents of a region table according to an embodiment.

TABLE 16

| Field Name | Data Type | Notes |
|---|---|---|
| Region | Int | Primary Key. |
| Id Name | String(30) | The region name. E.g. Scotland, |
| | | South East, North West, Midlands |
| CreatedOn | DateTime | The date the region was |
| | | created. NOT NULL |
| ModifiedOn | DateTime | The date the region was last |
| | | modified. |
| IsActive | Boolean | Determines if the region can be used |
| | | by the search engine. NOT NULL |

In an embodiment, a post area table defines all the post areas used within the system. This table is used by the search engine in order to retrieve locations for a specified post town. Table 17 illustrates the contents of a post area table according to an embodiment.

TABLE 17

| Field Name | Data Type | Notes |
|---|---|---|
| PostAreaId | Int | Primary Key |
| PostArea | String(2) | A two character code that represents |
| | | the post area. NOT NULL. |
| | | UNIQUE |
| PostTown | String(30) | The town/city used as the central |
| | | location for the post area. NOT |
| | | NULL. UNIQUE |
| RegionId | Int | The region to which the post area |
| | | belongs. Foreign Key References |
| | | Region.RegionId NOT NULL |
| Latitude | Numeric(9, 6) | The latitude of the post area using |
| | | the WGS84 standard. NOT NULL |
| Longitude | Numeric(9, 6) | The longitude of the post area using |
| | | the WGS84 standard. NOT NULL |
| CreatedOn | DateTime | The date the post area was |
| | | created. NOT NULL |
| ModifiedOn | DateTime | The date the post area was last |
| | | modified. |
| IsActive | Boolean | Determines if the region can be used |
| | | by the search engine. NOT NULL |

To further illustrate the content of Table 17, Table 18 illustrates the content of an exemplary category post area table according to an embodiment.

TABLE 18

| Post Area | Post Town | Region |
|---|---|---|
| AB | Aberdeen | Scotland |
| AL | St. Albans | South East |
| B | Birmingham | Midlands |
| BA | Bath | South West |
| BB | Blackburn | North West |
| BD | Bradford | North East |
| BH | Bthenemouth | South West |
| BL | Bolton | North West |
| BN | Brighton | South East |
| BR | Bromley | South East |
| BS | Bristol | South West |
| BT | Belfast | Northern Ireland |
| CA | Carlisle | North West |
| CB | Cambridge | East Anglia |
| CF | Cardiff | Wales |
| CH | Chester | North West |
| CM | Chelmsford | East Anglia |
| CO | Colchester | East Anglia |
| CR | Croydon | South East |
| CT | Canterbury | South East |
| CV | Coventry | Midlands |
| CW | Crewe | North West |
| DA | Dartford | South East |
| DD | Dundee | Scotland |
| DE | Derby | Midlands |
| DG | Dumfries | Scotland |
| DH | Durham | North East |

In an embodiment, a content provider table defines all the content providers that have contributed locations to the central database. Table 19 illustrates the contents of a content provider table according to an embodiment.

TABLE 19

| Field Name | Data Type | Notes |
|---|---|---|
| ContentProviderId | Int | Primary Key |
| Name | String(200) | The name of the company supplying |
| | | the content. |
| Description | String(100) | A description of the content |
| | | provider. |
| CreatedOn | DateTime | The date the content provider was |
| | | created. |
| ModifiedOn | DateTime | The date the content provider was |
| | | last modified. |
| Active | Boolean | TRUE - The search engine will use |
| | | the content provider |
| | | FALSE - The search engine will not |
| | | use the content provider |
| Logo | Byte(TBC) | Logo used by the content provider |
| | | for displaying within the mobile |
| | | application. This should be small, |
| | | in order that is does not impact |
| | | performance when returning data to |
| | | the client. |
| IsChargeable | Boolean | TRUE - The content provider |
| | | charges for any locations that is has |
| | | contributed. |
| | | FALSE - Content is provided free |
| | | of charge |
| IsNational | Boolean | TRUE - The content provider is |
| | | used for national searches. This will |
| | | ignore the postal area and category |
| | | configuration. |
| | | FALSE - The search engine will |
| | | use the postal area and category |
| | | configuration that has been defined. |

The content provider is identified by a unique “ContentProviderId.” A content provider is also identified as “national” or “local” using a Boolean operator. A national content provider provides information that is not grouped by postcodes or other location identifiers. If a content provider is identified as national, the search engine will disregard the postal area and category configuration information. A content provider category defines the set of categories that a content provider supports.

Table 20 illustrates a categories configuration file according to an embodiment for a content provider identified as national. The search engine will be able to distinguish regions based on the geocodes and will be able to define the boundaries of the various regions using a lookup table. This is dependent on how the regions are sectioned by the operator of the CDS.

TABLE 20

| Field Name | Data Type | Notes |
|---|---|---|
| ContentProviderCategoryCategoryId | Int | Primary Key |
| ContentProviderId | Int | Identifies the content |
| | | provider |
| CategoryId | Int | Identifies the category |

The ContentProviderId and CategoryId field combination will be unique.

A content provider postal area category defines the set of categories that are associated with a postal area for a specified content provider. For example, a content provider “YORKSHIRE PUBS AND RESTAURANTS” may have the categories PUBS for postal codes LS, BD, HX, and RESTAURANTS for postal codes LS, HX, S75. Table 21 illustrates a postal area category configuration file according to an embodiment.

TABLE 21

| Field Name | Data Type | Notes |
|---|---|---|
| ContentProviderPostal | Int | Primary Key |
| AreaCategoryId | | |
| ContentProviderId | Int | Identifies the content provider |
| PostalAreaId | Int | Identifies the postal area |
| CategoryId | Int | Identifies the category |

The ContentProviderId, PostalAreaId and CategoryId field combination will be unique. As previously indicated, a content provider that is identified as “national” does not provide content grouped by postcode. Thus, this configuration file is ignored by the search engine in the event that the content provider is defined as national.

As previously noted, the rules engine is configured to search databases of content providers and a central data base. As to the former, in order for the search engine to acquire data with from the content provider, the search engine is configured to use protocols recognized by the content provider. For example, service providers may utilize a web service, a HTTP GET implementation, or a HTTP POST implementation. Additionally, the search engine is configured to pass the parameters required by the content provider's interface in order to pass data requests to the content provider. For example, a content provider will be provided with at least a postcode, possibly a category (the content provider may only support one category), and maybe security details (in order that the content provider can validate the user requesting the information). By way of illustration, a HTTP GET message might be structured as follows: http://www.contentprovider.co.uk?postcode=LS11+5QP&category=1

The configuration files used to establish the communications between the search engine and the content provider are described below.

A protocol is used to define how the search engine communicates with the content provider in order to retrieve a list of locations. Table 12 illustrates a protocol configuration file according to an embodiment.

TABLE 22

| Field Name | Data Type | Notes |
|---|---|---|
| ProtocolId | Int | Primary Key |
| ContentProviderId | Int | Identifies the content provider |
| Description | String(50) | |

The string size set forth in Table 22 is considered exemplary and not limiting.

To illustrate this further, Table 23 illustrates the content of an exemplary protocol configuration file according to an embodiment.

TABLE 23

| ProtocolID | Description |
|---|---|
| 1 | HTTP GET |
| 2 | HTTP POST |
| 3 | SOAP |

A parameter is used to define the parameters used when communicating with a content provider. Table 24 illustrates a parameter configuration file according to an embodiment.

TABLE 24

| Field Name | Data Type | Notes |
|---|---|---|
| ParameterId | Int | Primary Key |
| Description | String(100) | |

The string size set forth in Table 24 is considered exemplary and not limiting.

To illustrate this further, Table 25 illustrates the content of an exemplary parameter configuration file according to an embodiment.

TABLE 25

| ParameterId | Description |
|---|---|
| 1 | PostCode |
| 2 | Category |

A content type defines how the protocol encodes the data that is sent to a content provider. Table 26 illustrates a protocol encoding configuration file according to an embodiment.

TABLE 26

| Field Name | Data Type | Notes |
|---|---|---|
| ContentTypeId | Int | Primary Key |
| Description | String(100) | |

The string size set forth in Table 26 is considered exemplary and not limiting.

To illustrate this further, Table 27 illustrates the content of an exemplary protocol encoding configuration file according to an embodiment.

TABLE 27

| ContentTypeId | Description |
|---|---|
| 1 | text/xml; charset = utf-8 |
| 2 | mobile application/x-www-form-url |
| | encoded |

A content provider protocol defines the protocols that are implemented by a content provider. Table 28 illustrates a provider protocol configuration file according to an embodiment.

TABLE 28

| Field Name | Data Type | Notes |
|---|---|---|
| ContentProviderProtocolId | | Primary Key |
| ContentProviderId | Int | Identifies the content provider |
| ProtocolId | Int | Identifies the protocol |
| Url | String(2000) | The url that is used to locate |
| | | the content provider. This |
| | | field is only used for the |
| | | HTTP GET and HTTP |
| | | POST protocols. |
| Preference | Int | The order in which the search |
| | | engine uses the content |
| | | provider when searching. |
| Active | Boolean | TRUE - Not used for |
| | | searching. |
| | | FALSE - Is used for |
| | | searching. |
| ContentTypeId | Int | NULL. Identifies the content |
| | | type. This is only required for |
| | | HTTP POST and SOAP |
| | | protocols. |
| XSLT | String(1000) | The XSLT that would be used |
| | | to transform the data |
| | | returned from the |
| | | content provider. |
| LastTestedOn | DateTime | The last time the content |
| | | provider protocol |
| | | was tested |

The ContentProviderId and ProtocolId field combination will be unique.

The string size set forth in Table 28 is considered exemplary and not limiting.

A content provider protocol configuration defines the set of parameter names and values that need to be specified for a content provider and protocol. Table 29 illustrates a parameter configuration file according to an embodiment.

TABLE 29

| Field Name | Data Type | Notes |
|---|---|---|
| ContentProviderProtocolConfigurationId | | Primary Key |
| ContentProviderProtocolId | Int | Identifies the |
| | | content |
| | | provider |
| | | and protocol |
| ParameterName | String(100) | Identifies the |
| | | parameter |
| | | name |
| ParameterValue | String(100) | Identifies the |
| | | parameter |
| | | value |

The string size set forth in Table 29 is considered exemplary and not limiting.

This configuration information is particularly useful when the content provider needs to be made aware of security details when using the specified protocol.

A content provider protocol parameter defines the content provider's representation of the parameters used by the search engine for a specified protocol. Table 20 illustrates a content provider parameter naming configuration file according to an embodiment.

TABLE 30

| Field Name | Data Type | Notes |
|---|---|---|
| ContentProviderProtocolParameterId | Int | Primary Key |
| ContentProviderProtocolId | Int | Identifies the content provider |
| | | and protocol |
| ParameterName | String(100) | Identifies the parameter name |
| ContentProvicerParameterName | String(100) | The name that is used by the |
| | | content provider to map onto the |
| | | ParameterId for the specified |
| | | protocol. This is the content |
| | | provider's interpretation of the |
| | | parameter name. |

The ContentProviderProtocolId and ParameterId field combination will be unique.

The string size set forth in Table 30 is considered exemplary and not limiting.

In an embodiment, the data that is returned from a content provider comprises a defined structure. Table 31 illustrates a data structure according to an embodiment.

TABLE 31

| Field Name | Data Type | Notes |
|---|---|---|
| Company Name | String | String length variable |
| AddressLine1 | String | String length variable |
| AddressLine 2 | String | String length variable |
| Postcode | String | String length variable |
| TelephoneNumber | String | String length variable |
| ItunesStyleStarRating | String | String length variable |
| Price Guide | String | String length variable |
| Description | String | String length variable |

In an embodiment, data that is returned from a content provider is in XML format.

The following is an exemplary response with multiple locations:

<?xml version=“1.0” encoding=“utf-8”?>
<locations>
<location>
<companyname>A Company Name</companyname>
<addressline1>An Address Line 1</addressline1>
<addressline2>An Address Line 2</addressline2>
<postcode>A PostCode</postcode>
<telephonenumber>1234 123456</telephonenumber>
<itunesstylestarrating>rating 1</itunesstylestarrating>
<priceguide>priceguide 1</priceguide>
<description>A brief description of the company</description>
</location>
<location>
<companyname>Another Company Name</companyname>
<addressline1>Another Address Line 1</addressline1>
<addressline2>Another Address Line 2</addressline2>
<postcode>Another PostCode</postcode>
<telephonenumber>7890 123456</telephonenumber>
<itunesstylestarrating> rating 2</itunesstylestarrating>
<priceguide>priceguide 4</priceguide>
<description>A brief description of another company</description>
</location>
</locations>
A response with no locations:
<?xml version=“1.0” encoding=“utf-8”?>
<locations>
</locations>

In another embodiment of the present invention, content providers store (cache) the data in a central database. In this embodiment, a search engine component of a client searches the central database and does not communicate directly with a content provider.

It is anticipated that various versions of the mobile application will be used. In an embodiment, a version table is used for distinguishing between the different versions of the mobile application. Table 32 illustrates the contents of a version table according to an embodiment.

TABLE 32

| Field Name | Data Type | Notes |
|---|---|---|
| ApplicationVersionId | Int | Primary Key |
| Version Name | String(200) | Version name |
| Description | String(100) | A description of mobile application |
| | | version |
| CreatedOn | DateTime | The date the record was created. |
| ModifiedOn | DateTime | The date the record was last |
| | | modified. |
| Active | Boolean | TRUE - The search engine will use |
| | | the mobile application Version |
| | | FALSE - The search engine will |
| | | not use the mobile application |
| | | Version |

In an embodiment, a content provider version table is a list of content providers that can be searched against for each mobile application version. This configuration table thus defines which content providers' data will be used for a particular version of the mobile application. Table 33 illustrates the contents of a content provider version table according to an embodiment.

TABLE 33

| | Data | |
|---|---|---|
| Field Name | Type | Notes |
| ContentProviderApplicationVersionId | Int | Primary Key |
| ContentProviderId | Int | Primary Key. |
| | | Foreign Key references |
| | | ContentProvider.ContentProviderId |
| ApplicationVersionId | Int | Primary Key. |
| | | Foreign Key references |
| | | ApplicationVersion.ApplicationVersionId |
| CreatedOn | DateTime | The date the content provider was |
| | | created. |
| ModifiedOn | DateTime | The date the content provider was last |
| | | modified. |
| Active | Boolean | TRUE - The search engine will use the |
| | | content provider FALSE - The search |
| | | engine will not use the content provider |

In an embodiment, a content provider location table defines all the content providers that are associated with locations. Since the location table is assumed to have unique establishments, this table allows the same location to be assigned to multiple content providers. Table 34 illustrates the contents of a content provider location table according to an embodiment.

TABLE 34

| Field Name | Data Type | Notes |
|---|---|---|
| ContentProviderId | Int | Primary Key. |
| | | Foreign Key |
| | | references ContentProvider.ContentProviderId |
| LocationID | Int | Primary Key. Foreign Key references |
| | | Location.LocationID NOT NULL. |
| CreatedOn | DateTime | The date the content provider/location was |
| | | created |
| ModifiedOn | DateTime | The date the content provider/location was |
| | | last modified |
| RestaurantReview | String(255) | A review of the restaurant when the specified |
| | | location is a restaurant |
| IsActive | Boolean | TRUE - The search engine will use the |
| | | content provider for the specified |
| | | location FALSE - The search engine will not |
| | | use the content provider |
| IsChargeable | Boolean | TRUE - The content provider charges for this |
| | | location. |
| | | False - The location is provided free of |
| | | charge. |

The CDS provides context-relevant information to users of mobile devices. The CDS thus utilizes existing infrastructure of a mobile gateway service provider to provide the communication between a mobile device and the content delivery system using short code messaging.

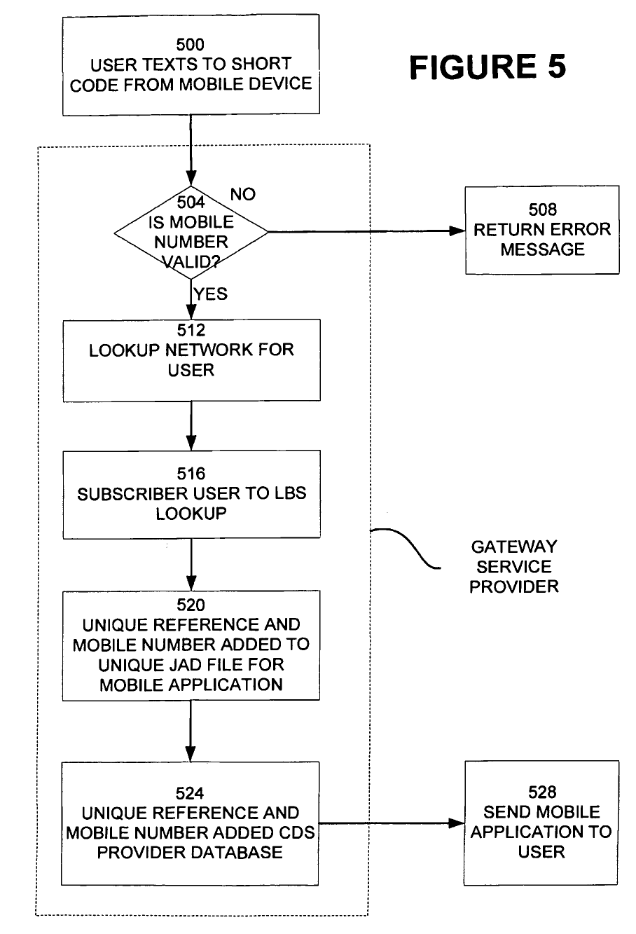

FIG. 5 illustrates a flow of a user subscribe flow according to an embodiment. A user desiring to subscribe to content delivery service sends a text message comprising a short code from a mobile device to the gateway service provider 500. The gateway service provider determines if the mobile number is valid 504. If the mobile is not valid, the gateway service provider returns an error message to the mobile device 508. If the mobile number is valid, the gateway service provider looks up the network of the user 512. The user is then subscribed to a location based service 516. The telephone number is associated with a unique reference number and added to a JAD file 520. The telephone number and the unique reference number are sent to the provider of the content delivery service 524. The unique reference number and telephone number are used for billing, audit and compliance or regulatory purposes. The mobile application is then sent by the provider of the content delivery service to the mobile device 528.

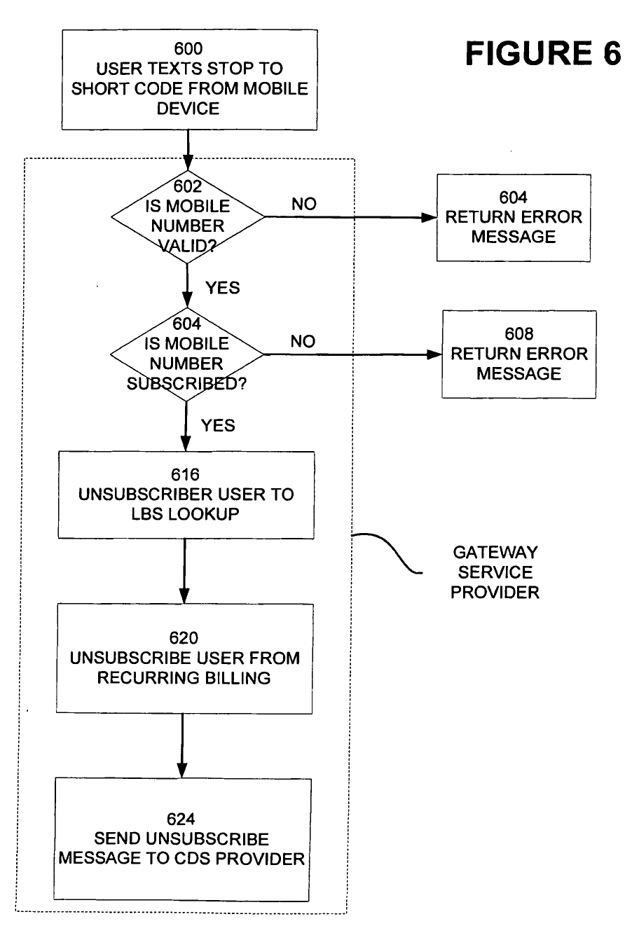

FIG. 6 illustrates a flow of a user subscribe flow according to an embodiment. In an embodiment, a user desiring to subscribe to content delivery service sends a text message comprising a stop short code from a mobile device to the gateway service provider 600. The use of a text message, however, is exemplary and not limiting. For example, a voicecode could be used in place of a text message. The gateway service provider determines if the mobile number is valid 602. If the mobile is not valid, the gateway service provider returns an error message to the mobile device 604. The gateway service provider determines if the mobile number is subscribed to the content delivery service 606. If the mobile is not valid, the gateway service provider returns an error message to the mobile device 608. If the mobile number is valid and the number is subscribed to the content delivery service, the mobile service unsubscribes the user from the location based server 616 and from recurring billing 620. An unsubscribe message is sent to the provider of the content delivery service 624.

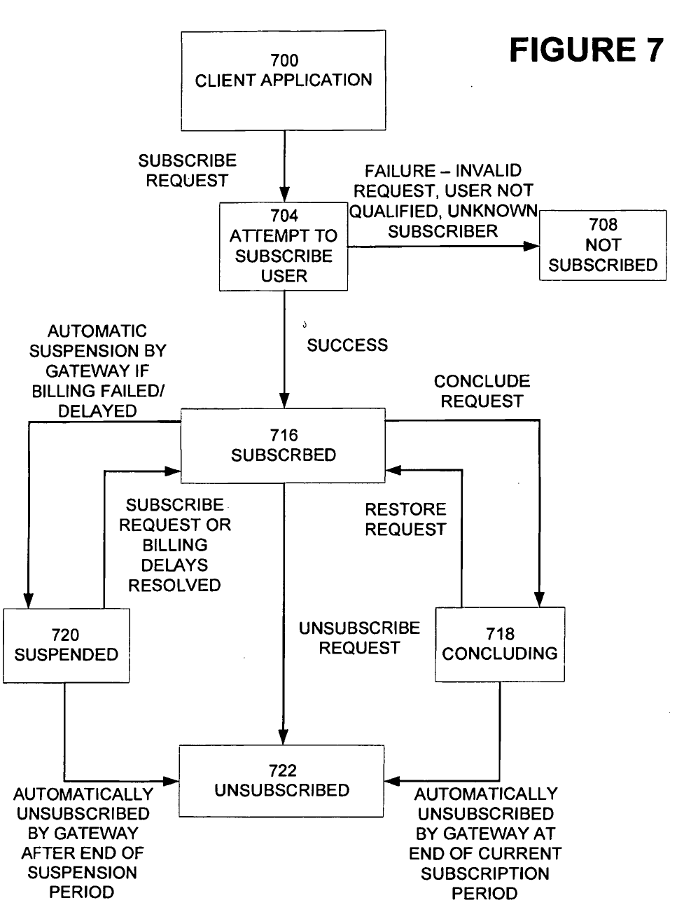

In both of these flows illustrated in FIGS. 6 and 7, a text or audio shortcode is used to authenticate the user. By using the shortcode, the user is voluntarily opting into the content delivery service and accepting legal and commercial terms associated with the service. The network lookup service is a transparent service provided by the gateway service provider for detecting the networks each mobile phone request is from. This is so that the appropriate network providers can be contacted for LBS data and recurring billing.

In an embodiment, when a user switches from one wireless network to another wireless network, the change in network is detected. However, because the recurring billing information and LBS is associated with the previous operator, a message is returned to the user asking the user to text to a mobile application shortcode to subscribe and download the latest copy of the mobile application.

By way of illustration and not as a limitation, the content delivery system obtains location based information from the gateway service provider via two interfaces, HTTP and XML/SOAP. HTTP/HTPPS has an advantage in that the packets are significantly smaller sized.

In an embodiment, a gateway service provider allows location requests to be made over HTTP to an LBS. The most common method of connecting to the gateway service provider's LBS is through the use of HTTP GET requests. The gateway service provider's LBS exposes an HTTP interface allowing applications with internet connectivity to locate a mobile handset. A request for a page using the structure shown below is used to locate a mobile handset using the Gateway service provider's LBS. The response given by the Gateway service provider's LBS can either be in plain text or XML format. The endpoints for these HTTP requests are Plain text http://lbs.serviceprovider.com/PlainLocate and https://lbs.serviceprovider.com/PlainLocate.

Requests may be sent as a HTTP GET or POST using the parameters listed below. When HTTP/1.1 is enabled, if sending multiple packets, the TCP/IP connection is kept open between requests. Table 35 sets forth the parameters for requests according to an embodiment.

TABLE 35

| Name | Description |
|---|---|
| user | Username of the account to use |
| pass | Password |
| msisdn | MSISDN of the mobile phone (eg |
| | 447781484950). No leading “+” is |
| | required |
| *timeout | Maximum lifetime of request in seconds |
| | (default 20 seconds, |
| | maximum 120) |
| *sync · | false - Make request asynchronously |
| | true - Make request synchronously (default) |
| *note | Note that will be stored in the billing record |
| | (maximum 160 characters) |
| *subaccount | Sub account that will be stored in the billing |
| | record (maximum 10 characters) |

The following example shows an HTTP request understood by the gateway service provider's LBS returning an XML formatted response: http://lbs.serviceprovider.com/Locate?user=myusername&pass=mypassword&msisdn=44778 1484950

If unset, timeout will be set to a default value. In an embodiment, the default value is 20 seconds. If a request is made synchronously, timeout will have a maximum value. In an embodiment, the maximum value is 20 seconds.

A response to a request comprises a status code indicating how the request has proceeded. If this status indicates an error, there will also be a plain text explanation. However, status codes are used for ease of parsing by applications. Table 36 illustrates an error code map according to an embodiment.

TABLE 36

| Code | Meaning |
|---|---|
| 0 | Success |
| 101 | Internal Configuration Error |
| 102 | Internal Error processing the request |
| 103 | Could not contact WapMX Server |
| 104 | Request missing compulsory parameter e.g. no msisdn set |
| 105 | Error in the format of the parameters |
| 106 | Internal Error while storing the request |
| 107 | Too many simultaneous synchronous requests: try again later, or |
| | asynchronously |
| 108 | Authentication error (user/pass incorrect) |
| 109 | Ythe daily limit of requests for that user has been exceeded |
| 110 | Ythe monthly limit of requests has been hit |
| 111 | You are not allowed to locate that user |
| 112 | Access denied to that account from the ip |
| 113 | Internal error has occurred |
| 201 | Unknown error |
| 205 | Request expired |
| 206 | The operator has no location for that msisdn |
| 207 | The operator rejected the request for the location of that msisdn |
| | (e.g. msisdn not on that network, often caused by attempting to |
| | locate a Virgin Mobile handset with a T Mobile account) |
| 209 | The connection to this operator is temporarily unavailable |
| 210 | The connection to this operator is temporarily saturated - try again |
| | later |
| 211 | The user is roaming |

Status codes 0 and 2xx (where x is a digit) indicate that a user will be billed for the request. Status codes 1xx indicate that the user will not be billed.

If the request is submitted to the PlainLocate endpoint (eg. http://lbs.serviceprovider.com/PlainLocate) the server will reply in plain text. The format is indicated by example:

1. Synchronous success

TABLE 37

| | |
|---|---|
| 0 | #status |
| 7589 | #requestid |
| 111111 | #msisdn |
| 2003-05-15 10:30:14 +0100 | #result date |
| 52.658058 | #latitude |
| 1.716111 | #longitude |
| 651413 | #eastings |
| 313188 | #northings |
| TG514131 | #landranger |
| 750 | #accuracy in metres (radius) |

2. Synchronous failure

TABLE 38

| | |
|---|---|
| 207 | #status |
| 7740 | #requestid |
| 111111 | #msisdn |
| Request rejected by operator | #plaintext reason |

3. Synchronous Rejection

TABLE 39

| | |
|---|---|
| 108 | #status |
| Authentication error | #plaintext reason |

4. Asynchronous success

TABLE 37

| | |
|---|---|
| 0 | #status |
| 7734 | #requestid |
| 111111 | #msisdn |

As formatted, everything after and including the # is a comment. As can be seen, if the status is 0, the request has been successful. If the status is of the form 1xx (where x is a digit) the request has been rejected. If the status is of the form (2xx) the request has failed. Again, if the request is accepted, the reply will have HTTP status 200, if the request is rejected, the reply will have HTTP status 403, with text indicating the error.

The Gateway service provider's LBS allows location requests to be made using SOAP over HTTP. A Web Services Definition Language (.wsdl) file describing the Location Gateway SOAP interface according to an embodiment is illustrated below:

<wsdl:definitions targetNamespace=“http://lbs.wapmx.com/ext/soap”
xmlns=“http://schemas.xmlsoap.org/wsdl/”
xmlns:apachesoap=“http://xml.apache.org/xml-soap”
xmlns:impl=“http://lbs.wapmx.com/ext/soap”
xmlns:intf=“http://lbs.wapmx.com/ext/soap”
xmlns:soapenc=“http://schemas.xmlsoap.org/soap/encoding/”
xmlns:tns1=“http://lbs.wapmx.com/ext/soap/types”
xmlns:wsdl=“http://schemas.xmlsoap.org/wsdl/”
xmlns:wsdlsoap=“http://schemas.xmlsoap.org/wsdl/soap/”
xmlns:xsd=“http://www.w3.org/2001/XMLSchema”>
− <wsdl:types>
− <schema targetNamespace=“http://lbs.wapmx.com/ext/soap/types”
xmlns=“http://www.w3.org/2001/XMLSchema”>
<import namespace=“http://schemas.xmlsoap.org/soap/encoding/” />
− <complexType name=“requestType”>
− <sequence>
<element name=“msisdn” nillable=“true” type=“xsd:string” />
<element name=“user” nillable=“true” type=“xsd:string” />
<element name=“pass” nillable=“true” type=“xsd:string” />
<element maxOccurs=“1” minOccurs=“0” name=“subaccount”
nillable=“true”
type=“xsd:string” />
<element maxOccurs=“1” minOccurs=“0” name=“note” nillable=“true”
type=“xsd:string” />
<element maxOccurs=“1” minOccurs=“0” name=“validity”
nillable=“true”
type=“xsd:int” />
<element name=“sync” type=“xsd:boolean” />
</sequence>
</complexType>
− <complexType name=“responseType”>
− <sequence>
<element name=“msisdn” nillable=“true” type=“xsd:string” />
<element name=“time” nillable=“true” type=“xsd:dateTime” />
<element name=“location” nillable=“true” type=“tns1:locationType” />
<element name=“error” nillable=“true” type=“tns1:errorType” />
<element name=“requestid” type=“xsd:int” />
<element name=“status” type=“xsd:int” />
</sequence>
</complexType>
− <complexType name=“locationType”>
− <sequence>
<element name=“longitude” type=“xsd:double” />
<element name=“latitude” type=“xsd:double” />
<element name=“eastings” type=“xsd:int” />
<element name=“northings” type=“xsd:int” />
<element maxOccurs=“1” minOccurs=“0” name=“accuracy”
nillable=“true”
type=“xsd:int” />
<element name=“landranger” nillable=“true” type=“xsd:string” />
</sequence>
</complexType>
− <complexType name=“errorType”>
− <sequence>
<element name=“message” nillable=“true” type=“xsd:string” />
</sequence>
</complexType>
</schema>
</wsdl:types>
− <wsdl:message name=“locateRequest”>
<wsdl:part name=“in” type=“tns1:requestType” />
</wsdl:message>
− <wsdl:message name=“locateResponse”>
<wsdl:part name=“out” type=“tns1:responseType” />
</wsdl:message>
− <wsdl:portType name=“lbsPort”>
− <wsdl:operation name=“locate” parameterOrder=“in”>
<wsdl:input message=“intf:locateRequest” name=“locateRequest” />
<wsdl:output message=“intf:locateResponse” name=“locateResponse” />
</wsdl:operation>
</wsdl:portType>
− <wsdl:binding name=“lbsSoap” type=“intf:lbsPort”>
<wsdlsoap:binding style=“rpc”
transport=“http://schemas.xmlsoap.org/soap/http” />
− <wsdl:operation name=“locate”>
<wsdlsoap:operation soapAction=“” />
− <wsdl:input name=“locateRequest”>
<wsdlsoap:body
encodingStyle=“http://schemas.xmlsoap.org/soap/encoding/”
namespace=“http://lbs.wapmx.com/ext/soap” use=“encoded” />
</wsdl:input>
− <wsdl:output name=“locateResponse”>
<wsdlsoap:body
encodingStyle=“http://schemas.xmlsoap.org/soap/encoding/”
namespace=“http://lbs.wapmx.com/ext/soap” use=“encoded” />
</wsdl:output>
</wsdl:operation>
</wsdl:binding>
− <wsdl:service name=“lbsService”>
− <wsdl:port binding=“intf:lbsSoap” name=“lbsPort”>
<wsdlsoap:address location=“http://lbs.wapmx.com/rpcrouter” />
</wsdl:port>
</wsdl:service>
</wsdl:definitions>
--End of XML--

In an embodiment, a content delivery system is provided in exchange for payment of fees. In one embodiment, a user pays for the service on a per use basis. In another embodiment, a user “subscribes” to the service. In this embodiment, a subscription describes a recurring charge applied to a single user, and is identified by the gateway with a single subscription Id generated by the gateway provider and a number of transaction Ids that relate to the individual charges that have been applied over the cthese of the subscription. A number of management operations can be applied to subscriptions; they can be unsubscribed, this means that the subscription is immediately and permanently ended. A request can also be made to conclude a subscription, which means that the subscription remains valid until the end of the current billing period, but after that time the subscription is automatically unsubscribed.

Subscriptions can be suspended, which means the subscription is deemed inactive, and should be unsubscribed after a defined period of time. Depending on the management options, the gateway may continue to attempt to bill the user in order to restore their subscription. This process will terminate once the user becomes unsubscribed. A user will be prevented from using a suspended service until the user has been successfully billed.

The mobile application may also manually restore the subscription, enabling the user to continue to use the service without being billed until the start of the next billing period. This may be used either automatically (to allow a number of billing failures before permanently unsubscribing the user) or manually (to respond to a customer services call).

A concluding subscription is a request to be terminated submitted by the user (perhaps via their online bill) or the client (via a customer services call). If the next billing period is reached, then the user will not be billed, and will be unsubscribed instead. If during the time a subscription is concluding, a restore request is created (perhaps via a customer services call) the user will re-enter the subscribed state, and will be billed again at the start of the next billing period.

If the billing frequency of a subscription is set to an arbitrary value (for example, “Every Goal”), then no automatic charges will be applied to the customer. The calling application will be responsible for instigating all charges. A charge may be applied to an active subscription at any time, with the sole exception that a charge request will be rejected if a charge is already in progress. Possible subscription states and their relationships are illustrated in FIG. 7. A client application issues a subscribe request 700. An attempt is made to subscribe the user 704. If the subscribe attempt fails the user is “not subscribed” 708. If the subscribe attempts succeeds, the use is “subscribed” 716. A “subscribed” user may be “suspended” 720. In an embodiment, suspension of a subscribed user occurs automatically if billing fails or is delayed. A suspended user will be subscribed if the issues with billing are resolved. A “suspended” user may be “unsubscribed” 722 if the issues giving rise to the suspension are not resolved before the end of the suspension period.

A subscribed user may be “concluding” at the request of a user 718. A concluding account may be restored to “subscribed” on request of the user. A concluding account may be “unsubscribed” 722 if the account is not restored before the end of the subscription period.

A “subscribed” user 716 may be “unsubscribed” 722 at the request of the user.

In a subscribe request, the calling application can choose to specify the recurring charge frequency and allow the gateway to process all the required charges automatically, or can manage the frequency of the charges itself by making explicit separate charge requests to the gateway as required, passing the subscriptionld as a request parameter. The ‘subscriptionPeriodUnits’ parameter indicates the required charge frequency required; if set to an arbitrary unknown value the gateway will not automatically charge the user. If the gateway manages the recurring charges, the instigating application is notified of all charges via the Notification API.

Table 38 illustrates parameters used to instigate a subscription for a user according to an embodiment:

TABLE 38

| Parameter | Required? | Description |
|---|---|---|
| action | Yes | The action to take, for a |
| | | subscribe request this should |
| | | be ‘subscribe’. |
| brand | No | Pre-provisioned brand ID for |
| | | accounts supporting multiple |
| | | brands. If not included, |
| | | default brand details will be |
| | | used. |
| transactionMode | Yes | The desired authorization and |
| | | confirmation mode. This |
| | | should be set to |
| | | ‘AutoConfirm’. |
| productId | No | The unique ID of the |
| | | subscription product being |
| | | sold. |
| amount | No* | The amount to be charged in |
| | | thousandths of the specified |
| | | currency. This must be a |
| | | positive number and may be |
| | | subject to account policy |
| | | restrictions. e.g. 45000 for 45 |
| | | GBP |
| currency | No* | A three character ISO 4217 |
| | | currency code which may be |
| | | subject to account policy |
| | | restrictions. e.g. GBP for |
| | | British Pounds |
| productGroup | No* | Top level product grouping, |
| | | this can be set to an arbitrary |
| | | value or ‘generic’ (max 35 |
| | | chars). |
| productCat | No* | Product category, this can be |
| | | set to an arbitrary value or |
| | | ‘generic’ (max 35 chars). |
| productSubCat | No* | Product Subcategory, this can |
| | | be set to an arbitrary value or |
| | | ‘generic’ (max 35 chars). |
| productName | No* | The product name; this will be |
| | | displayed to users within the |
| | | WAP trusted pages (max 35 |
| | | chars). |
| productDescription | No* | Brief description of the |
| | | product (max 200 chars). |
| isAdult | No* | The adult nature of the charge. |
| | | Possible values are: adult - the |
| | | product is an adult product |
| | | either - the product can be |
| | | adult or non adult nonadult - |
| | | the product is not an adult |
| | | product |
| providerType | No | The type of payment account |
| | | to use. This should be set to |
| | | “Mobile” |
| note | No | A descriptive note that will be |
| | | stored in the charge record |
| | | (max 160 chars) |
| subaccount | No | The subaccount that will be |
| | | stored in the charge record |
| | | (max 10 chars) |
| subscriptionFreePeriod | No* (not required if an | The initial free period |
| | arbitrary subscription period | expressed in units of |
| | unit is defined) | subscriptionFreePeriodUnits |
| subscriptionFreePeriodUnits | No* (not required if an | Possible values: Hthes Days |
| | arbitrary subscription period | Weeks Months |
| | unit is defined) | |
| subscriptionPeriod | No* (not required if an | The billing period expressed |
| | arbitrary subscription period | in units of |
| | unit is defined) | subscriptionPeriodUnits. |
| subscriptionPeriodUnits | No* (not required if an | Possible values: Hthes Days |
| | arbitrary subscription period | Weeks Months |
| | unit is defined) | |
| arbitrarySubscriptionPeriodUnits | No* (not required if an | An arbitrary unit value, e.g. |
| | arbitrary subscription period | ‘Goal + Alert’ (max 35 chars). |
| | unit is defined) | If such a value is used the |
| | | gateway will not make charge |
| | | the user automatically. This |
| | | text will be displayed to the |
| | | user on subscription setup. |
| arbitrarySubscriptionPeriodUnits | No* (not required if an | Number of periods before the |
| | arbitrary subscription period | subscription automatically |
| | unit is defined) | terminates or 0 for perpetual |

Values in the required column of Table 38 marked with “*” indicate that the details can be specified by the subscription product referred to by the given product Id. Alternatively they are specified on a per “subscribe request” basis where the account policy permits. In this instance all parameters are required.

Additional parameters specific to the provider type used can also be supplied. In the case of the ‘mobile’ provider type, the user's mobile number can be provided as illustrated in table 38A:

TABLE 38A

| Parameter | Required? | Description |
|---|---|---|
| msisdn No | No | The mobile number of the user |
| | | to be charged in international |
| | | format with no leading +. e.g. |
| | | 447890123456 |

If the user's mobile number is not provided as a request parameter it will be obtained through the user visiting the WAP payment pages. The gateway will indicate in its response that user input is required and provide a billing URL for the required page. Table 38B illustrates additional that parameters are returned in addition to the common response information:

TABLE 38B

| Parameter | Returned if: | Description |
|---|---|---|
| subscriptionId | Outcome is success, | Outcome is success, failed or |
| | failed or | The unique ID of the new |
| | userinputrequired. | subscription.userinputrequired. |
| | | This is a 64-bit unsigned |
| | | integer. |
| redirectUrl | userinputrequired. | URL to redirect user to in |
| | | order to Outcome is complete |
| | | the transaction. |
| | | e.g.http://mxpay.net/12345678 |

By way of illustration and not as a limitation, a subscribe request may expressed as follows:

https://cta.serviceprovider.com/api?username=myUser&password=
myPass&action=subscribe&transactionMode=
AutoConfirm&providerType=mobile&productGroup=
group1&productCat=category1&productSubCat=
subcategory1&productDescription=My+test+
subscription&productName=Test+Product&amount= [symbol]
=GBP&isAdult=either&subscriptionPeriod=
1&subscriptionPeriodUnits=Months&subscriptionDuration=12

Table 39 illustrates the parameters of unsubscribe request according to an embodiment:

TABLE 39

| Parameter | Required? | Description |
|---|---|---|
| action | Yes | The action to take, for an |
| | | unsubscribe request this |
| | | should be ‘unsubscribe’. |
| subscriptionId | Yes | The unique ID of the |
| | | subscription to be |
| | | unsubscribed. |

By way of illustration and not as a limitation, an unsubscribe request may expressed as follows:

https://cta.serviceprovider.com/api?usemame=customer&password=
mypass&action=unsubscribe&subscriptionId=7482048

Table 40 illustrates the parameters of a conclude request according to an embodiment:

TABLE 40

| Parameter | Required? | Description |
|---|---|---|
| action | Yes | The action to take, for an |
| | | unsubscribe request this |
| | | should be |
| | | ‘concludeSubscription’. |
| subscriptionId | Yes | The unique ID of the |
| | | subscription to be concluded. |

By way of illustration and not as a limitation, a conclude request may expressed as follows:

https://cta.serviceprovider.com/api?username=myUser&password=
myPass&action=concludeSubscription&subscriptionId=7482048

Table 41 illustrates the parameters of a restore request according to an embodiment:

TABLE 41

| Parameter | Required? | Description |
|---|---|---|
| action | Yes | The action to take, for an |
| | | unsubscribe request this |
| | | should be |
| | | ‘restoreSubscription’. |
| subscriptionId | Yes | The unique ID of the |
| | | subscription to be concluded. |

By way of illustration and not as a limitation, a restore request may expressed as follows:

https://cta.serviceprovider.com/api?username=myUser&password=
myPass&action=restoreSubscription&subscriptionId=7482048

In an embodiment, communication with the gateway service provider's SMS Server is through the use of HTTP GET requests. The gateway service provider's SMS server exposes an HTTP interface allowing applications with internet connectivity to send SMS text messages. A request for a page using the structure shown below is all that is needed for a user to send an SMS through the gateway service provider's SMS Server. By way of illustration and not as a limitation, the endpoints for these HTTP requests are http://sms.serviceprovider.com/SMSSend for HTTP and https://sms.serviceprovider.com/SMSSend for HTTPS (SSL). In an embodiment, messages are sent as either a HTTP GET or POST using the parameters listed below. One request is sent per message. When HTTP/1.1 is enabled and when sending multiple packets, the TCP/IP connection is kept open between requests. If sending message with a high transmission rate is required, then several persistent HTTP/1.1 connections may be used concurrently (perhaps 3 or 4). In another embodiment, pipelining requests (ala Mozilla) is supported. Pipeling is best suited for circumstances in which high message rates and large latency between customer and the gateway service provider are needed.

Several parameters are common to all message types and are to be included in the HTTP request regardless of the specific method being invoked. Details of these parameters are illustrated in Table 42:

TABLE 42

| Name | Description |
|---|---|
| user | Username of the account to send through |
| pass | Password |
| smsto | MSISDN of the message recipient (eg |
| | 447771824154). No leading “+” is required |
| originator | Originator for the message (ignored for |
| | accounts where changing the*smsfrom is |
| | not possible). Where valid this can be |
| | numeric (maximum 16 digits) or |
| | alphanumeric (maximum 11 digits) |
| *note | Note that will be stored in the billing record |
| | (maximum 160 characters) |
| *subaccount | Sub account that will be stored in the billing |
| | record (maximum 10 characters) |
| *report | Flags for delivery reports (These are bit |
| | fields, ie report = 7 enabled all reports - |
| | default = 0): Bit 1 -Enable intermediate |
| | delivery reports Bit 2 -Enable success |
| | delivery reports Bit 3 -Enable failure |
| | delivery reports |
| *vp | Validity period for the message, in seconds |

Parameters of Table 42 marked with “*” indicate that are optional.

By way of illustration and not as a limitation, an HTTP request may have the following structure:

http://sms.serviceprovider.com/SMSSend?user=myusername&pass=
mypassword&smsfrom=1234
&smsto=44778148446&...other parameters...

Along with these parameters, there are a variety of other parameters which are used for the message body, depending on the preference for the encoding/content of the message.

In an embodiment, the responses to GET requests utilize standard internet three digit reply codes: broadly speaking, 20× implies success, 40× implies bad request, and 50× implies server errors. When a message is successfully received by the gateway service provider's SMS server a HTTP success will be returned to the caller (200 code) and the HTTP body will contain one or more message identifiers. These identify messages, and will be used in delivery reports.

By way of illustration and not as a limitation, a GET transaction may be appear as follows:

GET
/SMSSend?user=username&pass=password&smsfrom=
1234&smsto=44778148446&sms
msg=Hello HTTP/1.1
Host: sms.serviceprovider.com
HTTP/1.1 200 OK
Date: Tue, 25 Jun 2002 13:00:20 GMT
Server: Apache/1.3.26 (Unix) mod_ssl/2.8.8 OpenSSL/0.9.6a
Content-Type: text/plain
Transfer-Encoding: chunked
9
21343457

0

By way of illustration and not as a limitation, a multi-part GET transaction may be appear as follows:

GET
/SMSSend?user=username&pass=password&smsfrom=1234&smsto=44778148446&1
ogo_type=PICTURE&smsmsg=Hello&img=89504e470d0a1a0a0000000d49484452000
000480000001c0103000000f83c6be500000006504c5445000000ffffffa5d99fdd00
000001624b47440088051d48000000d94944415478da358e318ac26010855fd6620bc
bb5b7703b1b0bc1321ec2c1c22207d80b586996bd86a0f59f22365a08a282a596b2ed
160b4a1a450c09a2794e4c9ce2f1f1bd1918ff039719fc828b45f140c09c072814f875
8e2ad09eb3058691b2fc87f27dd5b7e93a7454a755874fb4530b93636caeaee97ea74
54785250d9b6ec75178c5bd5ae2a7531a6b033fa19bff3f6b1076f1d3755ea12645f6
8ba059e6b7f25303a4647e6b728e76d3e2ff289df8cda84e7930e032f81b49399e7ef
e40e6328e218ef0a912830739150dd8ct2a5a94e7a66128a3c005faab5918832af320
000000049454e44ae426082 HTTP/1.1
Host: sms.serviceprovider.com
HTTP/1.1 200 OK
Date: Mon, 01 Jul 2002 17:01:38 GMT
Server: Apache/1.3.26 (Unix) mod_ssl/2.8.8 OpenSSL/0.9.6a
Content-Type: text/plain
Transfer-Encoding: chunked
1b
22098253
22098254
22098255
0

Note that the numbers either side of the message ids are present as a result of the “chunked” transfer-encoding and will be stripped out by a browser or other transfer agent.

In the case of a forbidden operator (invalid username/password or attempting to send a reverse billing message where not allowed) the servlet will return an HTTPForbidden error (code 403) and the body will contain an error message. A transaction induced error of this type is illustrated as follows:

```
GET
/SMSSend?user=username&pass=
incorrectpassword&smsfrom=1234&smsto=4477
8148446&smsmsg=Hello HTTP/1.1
Host: sms.serviceprovider.com
HTTP/1.1 403 Forbidden
Date: Tue, 25 Jun 2002 12:59:31 GMT
Server: Apache/1.3.26 (Unix) mod_ssl/2.8.8 OpenSSL/0.9.6a
Content-Type: text/plain
Transfer-Encoding: chunked
20 Forbidden
  Bad username/password
  0
```

In the case of a bad request—eg parameters missing/invalid the servlet will return a Bad request error (code 400). A transaction induced error of this type is illustrated as follows:

GET
/SMSSend?user=username&pass=
incorrectpassword&smsfrom=1234&smsto=4477
8148446 HTTP/1.1
Host: sms.serviceprovider.com
HTTP/1.1 403 Forbidden
Date: Tue, 25 Jun 2002 12:59:31 GMT
Server: Apache/1.3.26 (Unix) mod_ssl/2.8.8 OpenSSL/0.9.6a
Content-Type: text/plain
Transfer-Encoding: chunked
21
Bad Request
Request type
unknown
0

If there is a problem with the gateway service provider's server then a 500 Internal server error will be returned. The customer should wait a few seconds and reattempt to send their message.

In an embodiment, the HTTP request comprises the common parameters described above and the plain-text-specific parameters set forth in Table 42A:

TABLE 42A

| Name | Description |
|---|---|
| smsmsg | The message text |
| *flash | 0 -No flash (Default) |
| | 1 -Flash |
| *split | 0 -Don't split long messages. Messages >160 |
| | characters will be rejected. (Default) |
| | 1 -Split messages using “ . . . ” (Maximum of |
| | 5 messages once split) |
| | 2 -SMS Concatenation (w. UDH header) - |
| | not supported by all phones (Maximum of |
| | 4 messages once split) |
| | 3 -Split messages into multiple 160 |
| | character messages (Maximum of 5 |
| | messages once split) |

Parameters of Table 42A marked with “*” indicate that are optional.

By way of illustration and not as a limitation, an HTTP message may have the following structure:

http://sms.serviceprovider.com/SMSSend?user=
myusername&pass=mypassword&smsfrom=
1234&smsto=44778148446&smsmsg=Hello%20World

By way of illustration and not as a limitation, a flash message may have the following structure:

http://sms.serviceprovider.com/SMSSend?user=myusername&pass=
mypassword&smsto=44778148446&smsfrom=flash&smsmsg=
Flashy%20Message&report=7&flash=1

This will send a message from the account of user (username), with password (mypassword), to recipient number 44778148446, with the originator of the message set to 1234 (this may not always be possible). The message, in this case Hello World must be suitably URL encoded (eg the %20 rather than a space).

Along with these parameters, there are a variety of other parameters which may be include in the message body, depending on the preference for the encoding/content of the message.

In an embodiment, the CDS uses GPS to obtain location information. In this embodiment, the wireless mobile device comprises a GPS location system. The mobile application interfaces with GPS location system to get location information. In an embodiment, the mobile application comprises detection logic to switch between LBS and GPS depending on availability. For example, in a building GPS may not work effectively, and LBS would be used. In an open space, GPS is would be used to provide more accurate location data.

In an embodiment, content providers are remunerated for providing content. In this embodiment, the results for each content provider need to be tracked and logged. In another embodiment, the CDS allows for differences between different content providers. For example, content provider A may have a revenue split of 50/50 whereas content provider B may have 70/30.

As described previously, Table 5 captures details all the licenses held by all content providers.

Table 5 captures the details of licenses held by all content providers. Table 43 captures the details of a license audit table that is captured from the license table:

TABLE 43

| Field Name | Data Type | Notes |
|---|---|---|
| LicenseauditID | Int | Primary Key. |
| LicenseId | Int | Foreign Key References |
| | | Licence.LicenceId |
| | | NOT NULL |
| ContentProviderID | Int | Foreign Key |
| | | References ContentProvider.ContentProviderId |
| | | NOT NULL |
| LicenseAmount | Numeric(9, 2) | The amount of the license (pounds) for the |
| | | period. NOT NULL |
| LicenseStart | DateTime | The date the license starts. NOT NULL |
| LicenseEnd | DateTime | The date the license ends. LicenseEnd >= |
| | | LicenseStart NOT NULL |
| LicenseAmountPerDay | Numeric(9, 2) | The amount the license is worth for each |
| | | day. LicenseAmountPerDay = |
| | | LicenseAmount/(LicenseEnd − |
| | | LicenseStart) CALCULATED NOT NULL |
| CreatedOn | DateTime | The date the record was created. NOT |
| | | NULL |
| ModifiedOn | DateTime | The date the record was last modified |

Table 44 illustrates an accounting period table that defines monetary and summary values for a specified period of time according to an embodiment:

TABLE 44

| Field Name | Data Type | Notes |
|---|---|---|
| AccountingPeriodId | Int | Primary Key. |
| PeriodStart | DateTime | The start date of the accounting period |
| PeriodEnd | DateTime | The end date of the accounting period. |
| | | PeriodEnd >= PeriodStart |
| LicenseRevenue | Numeric(10, 2) | The total license revenue for the |
| | | accounting period. This is calculated |
| | | from the license table, whereby the |
| | | License.LicenseAmountPerDay is |
| | | multiplied by (PeriodEnd − |
| | | PeriodStart) for every day every license |
| | | is valid in the specified accounting |
| | | period. NOT NULL |
| TotalRevenue | Numeric(10, 2) | The total revenue received for this |
| | | accounting period. This is the amount |
| | | of money that has been received |
| | | through billing the client. NOT NULL |
| NetRevenue | Numeric(10, 2) | The revenue that is to be split between the |
| | | content providers. NOT NULL |
| TotalChargeableLocations | Int | Total number of chargeable locations |
| | | returned in this accounting period. |
| | | NOT NULL |
| TotalFreeLocations | Int | Total number of free locations returned |
| | | in this accounting period. NOT NULL |
| CreatedOn | DateTime | The date the record was created. NOT |
| | | NULL |
| ModifiedOn | DateTime | The date the record was last modified |

In an embodiment, Table 45 illustrates a Transaction Table and Table 46 illustrates a Transaction Log table. In this embodiment, the Transaction Table and the TransactionLog Table are maintained separately because, there could be three separate transaction logs in one transaction. For example, when a user is returned 3 results at the end of the search, it is one transaction with 3 transaction logs. This way, the transaction logs can be associated with a particular session.

TABLE 45
Transaction Table

| Field Name | Data Type | Notes |
|---|---|---|
| TransactionID | Int | Primary Key |
| UserID | Int | |
| CategoryID | Int | |
| CreatedOn | DateTime | The date the transaction |
| | | was created. NOT NULL |

TABLE 46
TransactionLog Table

| Field Name | Data Type | Notes |
|---|---|---|
| TransactionLogID | Int | Primary Key Foreign Key |
| | | Reference Transaction.TransactionID |
| TransactionID | Int | |
| ContentProviderID | Int | |
| LocationID | Int | |
| CreatedOn | DateTime | The date the transaction was created. |
| | | NOT NULL |

In an embodiment, Table 47 illustrates a transaction table comprising detailed information regarding each stage of the location searching process. In order to track incomplete transactions, i.e. those transactions that failed due to a network failure, database failure, web server failure etc., a transaction record is created using the ClientRequest, StartedOn, and Status data and, then updated on completion of the transaction with the additional data. A transaction is only deemed successful if it has completed all the necessary steps in the allocated time and has returned at least one location to the client.

TABLE 47

| Field Name | Data Type | Notes |
|---|---|---|
| TransactionId | Int | Primary Key |
| ClientRequest | String(1000) | This will be the query string from |
| | | the HTTP GET client request. |
| | | NOT NULL |
| Status | Int | 1: Transaction completed |
| | | successfully 2: Transaction failed. |
| | | 3: Transaction started 4+: Other |
| | | status values TBC. |
| ServerResponse | String(1000) | The response sent back to the |
| | | client. |
| WhiteLabelContentProviderId | Int | The content provider that is used |
| | | when the engine is to search |
| | | content belonging to only one |
| | | content provider. This value will be |
| | | NULL when all content providers |
| | | are to be searched. Foreign Key |
| | | references |
| | | ContentProvider.ContentProviderId. |
| UserId | Int | |
| CategoryId | Int | Foreign Key |
| | | references Category.CategoryId. |
| MobileTelephoneNetwork | Int | The mobile number's network. 1: |
| | | Orange 2: Vodafone 3: O2 4: T- |
| | | Mobile 5: Virgin 6: Other |
| MobileTelephoneNumber | String(15) | The mobile telephone number. |
| StartedOn | DateTime | The date and time the transaction |
| | | started. |
| CompletedOn | DateTime | The date and time the transaction |
| | | was completed. |
| Latitude | Numeric(6, 3) | The latitude of the mobile |
| | | telephone (WGS84 standard) as |
| | | determined by the location based |
| | | service. |
| Longitude | Numeric(6, 3) | The longitude of the mobile |
| | | telephone (WGS84 standard) as |
| | | determined by the location based |
| | | service |
| BillingStartedOn | DateTime | The date and time the billing |
| | | started |
| BillingCompletedOn | DateTime | The date and time the billing was |
| | | completed |
| BillingReference | String | The billing reference received |
| | | from the billing company. FIELD |
| | | LENGTH TBC. |
| LBSLookupStartedOn | DateTime | The date and time the location |
| | | based service lookup started |
| LBSLookupCompletedOn | DateTime | The date and time the location |
| | | based service lookup was |
| | | completed |
| PostcodeLookupStartedOn | DateTime | The date and time the postcode |
| | | lookup started. This value will be |
| | | NULL when the postcode lookup |
| | | is not required. |
| PostcodeLookupCompletedOn | DateTime | The date and time the postcode |
| | | lookup was completed. This value |
| | | will be NULL when the postcode |
| | | lookup is not required. |
| LocationSearchStartedOn | DateTime | The date and time the location |
| | | search started. |
| LocationSearchCompletedOn | DateTime | The date and time the location |
| | | search was completed. |
| LBSLookupDuration | Numeric(6, 3) | LBSLookupCompletedOn − |
| | | LBSLookupStartedOnCALCULATED |
| LocationSearchDuration | Numeric(6, 3) | LocationSearchCompletedOn − |
| | | LBSLookupStartedOnCALCULATED |
| BillingDuration | Numeric(6, 3) | BillingCompletedOn − |
| | | BillingStartedOn CALCULATED. |
| TotalDuration | Numeric(6, 3) | CompletedOn − |
| | | StartedOnCALCULATED. |

In an embodiment, Table 48 illustrates a transaction item table comprising the locations that were supplied for each transaction. It is assumed that the LocationId is unique for the same TransactionId. For example, a suitable candidate key would be TransactionId, LocationId.

TABLE 48

| Field Name | Data Type | Notes |
|---|---|---|
| TransactionItemId | Int | Primary Key |
| TransactionId | Int | Foreign Key |
| | | References Transaction.TransactionId. |
| | | NOT NULL. |
| ContentProviderId | Int | Foreign Key |
| | | References |
| | | ContentProvider.ContentProviderId. |
| | | The content provider that provided |
| | | the location. NOT NULL. |
| LocationId | Int | Foreign Key References |
| | | Location.LocationId. Is it |
| | | assumed that the location information is |
| | | static; hence we can use a reference |
| | | to the location table. NOT NULL. |
| IsChargeable | Boolean | TRUE - The content provider |
| | | charges for this location. FALSE - The |
| | | location is provided free of charge. |
| CreatedOn | DateTime | The date the transaction item |
| | | was created. NOT NULL. |

In an embodiment, the CDS provides error reporting at points of failure. Error reports are logged into a database. This allows an error to be easily isolated and where required provide customers (content providers) with reporting during outages.

Table 49 illustrates an errors sthece table comprising all the entities that can log an error according to an embodiment:

TABLE 49

| Field Name | Data Type | Notes |
|---|---|---|
| ErrorStheceId | Int | Primary key |
| Sthece | String(100) | E.g. LBS Service Error Postcode Lookup |
| | | Error |
| | | Billing Service Error |
| | | Search Engine Service Error |
| | | Unknown Error (Unhandled exceptions) |
| CreatedOn | DateTime | The date the record was created |
| ModifiedOn | DateTime | The date the record was last modified |

Table 50 illustrates an errors table comprising all the errors that have occurred according to an embodiment:

TABLE 50

| Field Name | Data Type | Notes |
|---|---|---|
| ErrorLogId | Int | Primary key |
| Description | String(1000) | A description of the error. NOT NULL |
| StackTrace | String(1000) | Used as a diagnostic to determine where |
| | | the failure occurred within the codebase. |
| ErrorStheceId | Int | The sthece of the error. Foreign key |
| | | references ErrorSthece.ErrorStheceId. |
| ErrorCode | Int | An error code that is associated with the |
| | | error that has been logged. |
| TransactionId | Int | The transaction that is in error. Foreign |
| | | key |
| | | references TransactionId.TransactionId. |
| | | NULL |
| CreatedOn | Int | The date the record was created |

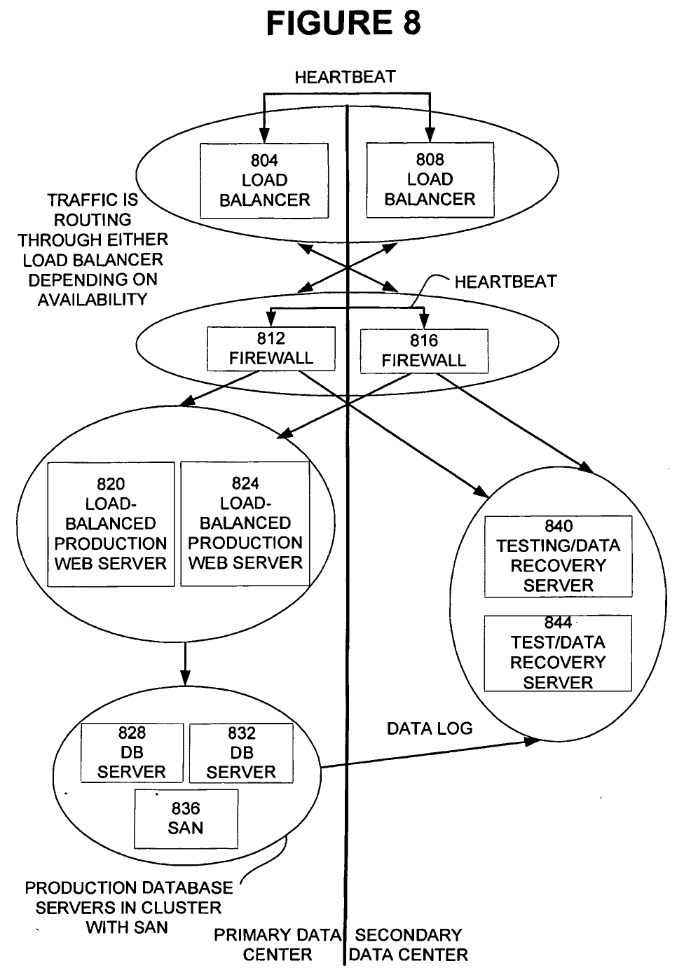

FIG. 8 illustrates a block diagram of an architecture for hosting a content delivery service according to an embodiment. As illustrated in FIG. 8, redundant load balancers 804 and 808 route traffic depending on their load and availability. The two load balancers are illustrated as being located in primary and secondary data centers. Should one load balancer fail then traffic to the hosted environment will be routed through a secondary load balancer which is also hosted in a secondary data centre. Firewalls 812 located in the primary datacenter and firewall 816 located in the secondary datacenter utilize “heartbeat” monitoring. Should one firewall find a fault then the other will take over responsibilities seamlessly.

In the primary data center, production webservers 820 and 824 communicate with database servers 828 and 832 clustered using a Storage Area Network (SAN) 836 to serve and store data. There is also the option to add additional webservers should mobile application anticipate higher concurrent usage and unique visitors.

Web server 820 and 824 are assigned virtual IP addresses. The virtual IP addresses are hosted on load balancers 804 and 808, which route traffic to virtual IP's of webservers through firewall.

Database servers 828 and 832 utilize a a two node cluster and use the fastIO (Input/Output) of SAN 836 to maintain disk high performance while storing and serving the data back to the DB cluster. A two database server cluster means that one server will be live (master) while the other will be passive (slave) unless there is a fault whereby the slave will become the master until the original master returns to operational status.

In an embodiment, the primary data center and the secondary data center are located in separate physical locations. In this embodiment, the secondary data center is secured behind a load balancer and a firewall. The secondary test data center may be used for testing and for receiving the log data. In an embodiment, the log data is sent to the secondary data center on a 15-30 second periodical basis and stored on testing/data recovery servers 840 and 844.

It will be understood by those skilled in the art that the structures and methods described herein may be embodied in other specific forms without departing from the scope of this disclosure and that the examples and embodiments described herein are in all respects illustrative and not restrictive. Those skilled in the art will recognize that other embodiments using the concepts described herein are also possible. Further, any reference to claim elements in the singular, for example, using the articles “a,” “an,” or “the” is not to be construed as limiting the element to the singular. Moreover, a reference to a specific time, time interval, and instantiation of scripts or code segments is in all respects illustrative and not limiting.

1. A system for providing location-based information to a mobile device comprising:
a datastore, wherein the datastore comprises a profile for each of a plurality of content providers, wherein the profile of each content provider comprises one or more categories of points of interest (POI) within one or more geographic areas for which a content provider provides POI information and a rank, and wherein each point of interest is associated with POI information and is a member of a category;
a server, wherein the server is accessible to the mobile device via a first communication path and accesses the datastore via a second communication path, and wherein the server comprises instructions for:
receiving a request for information concerning a category of POI from the mobile device;
in response to the request, acquiring location information indicative of a location of the mobile device at a time the request is received;
accessing the datastore;
matching the location information and the requested category to the profiles of the plurality of content providers to obtain a list of content providers providing POI information for the requested category within a geographic area that includes the location of the mobile device;
ordering the list of content providers according to the rank;
acquiring the POI information for the requested category from the list of content providers;
creating a list of candidate members of the requested category that are within a first distance from the location of the mobile device, wherein each entry on the list of candidate members is associated with the first content provider on the list of content providers to provide such entry; and
sending the POI information for each listed candidate member to the mobile device.

2. The system of claim 1, wherein mobile device is a cellphone.

3. The system of claim 1, wherein the points of interest are selected from the group consisting of a place, a restaurant, a park, a theater, a business address, a residential address, a location of an event, and a location of another person.

4. The system of claim 1, wherein the first communication path is provided via a wireless network and wherein the second communications path is provided via a wired network.

5. The system of claim 1, wherein the first and second communications paths are provided via wireless networks.

6. The system of claim 1, wherein the server further comprises instructions for:
receiving a user selection of one of the listed candidate members; and
sending POI information associated with the selected candidate member.

7. The system of claim 6, wherein the POI information is selected from the group consisting of a location, a telephone number, an address, a distance from the location of the mobile device, a travel time from the location of the mobile device to the one of the listed members, a cuisine, a review, operating hours, a performance time, a price range, a service offering, and a menu offering.

8. The system of claim 1, wherein the instruction for creating a list of candidate members of the requested category that are within a first distance of the location of the mobile device comprises:
receiving a list length equal to a preset number of candidate member entries;
determining a count of the candidate member entries; and
when the count of candidate member entries is equal to the list length, then creating the list of candidate members using the candidate member entries.

9. The system of claim 1, wherein the instruction for creating a list of members of the requested category that are within a first distance from the location of the mobile device comprises:
receiving a list length equal to a preset number of candidate member entries;
determining a count of the candidate member entries; and
when the count of candidate member entries is greater than the list length then:
grouping the candidate member entries according to an actual distance from the location of the mobile device starting with a most proximate candidate member; and
creating the list of candidate members by selecting a number of entries from the grouping of candidate members starting with the most proximate member equal to the list length.

10. The system of claim 1 further comprising, prior to sending the POI information for each listed candidate member to the mobile device:
receiving a list length equal to a preset number of candidate member entries;
determining a first count of the first candidate member entries;
when the first count of first candidate member entries is less than the list length then:
creating a second list of candidate members of the requested category that are within a second distance from the location of the mobile device, wherein each entry on the second list of candidate members is associated with the first content provider on the second list of content providers to provide such entry;
determining a total count comprising the first count of first candidate member entries plus a second count of second candidate member entries;
when the total count of candidate member entries is equal to the list length, then creating the list of candidate members using the first and second candidate member entries;
when the total count of candidate members entries is greater than the list length, then:
grouping the first and second candidate member entries according to an actual distance from the location of the mobile device starting with a most proximate candidate member; and
creating the list of candidate members by selecting a number of entries from the grouping of candidate members starting with the most proximate member equal to the list length.

11. (canceled)

12. A method for providing location-based information to a mobile device comprising:
establishing a datastore comprising a profile for each of a plurality of content providers, wherein the profile of each content provider comprises one or more categories of points of interest (POI) within one or more geographic areas for which the content provider provides POI information and a rank;
associating each point of interest with POI information information, wherein each point of interest is a member of a category;
receiving a request for information concerning a category of POI from the mobile device via a first communications path;
in response to the request for, POI information, acquiring location information indicative of a location of the mobile device at a time the request is received;
accessing the data store;
matching the location information and the requested category to the profiles of the plurality of content providers to obtain a list of content providers providing POI information for the requested category within a geographic area that includes the location of the mobile device;
ordering the list of content providers according to the rank;
acquiring the POI information for the requested category from the list of content providers;
creating a list of candidate members of the requested category that are within a first distance from the location of the mobile device, wherein each entry on the list of candidate members is associated with the first content provider on the list of content providers to provide such entry; and
sending the identifying information of the list of members to the mobile device.

13. The method of claim 12, wherein mobile device is a cellphone.

14. The method of claim 12, wherein the points of interest are selected from the group consisting of a place, a restaurant, a park, a theater, a business address, a residential address, a location of an event, and a location of another person.

15. The method of claim 12, wherein the first communication path is provided via a wireless network and wherein the second communications path is provided via a wired network.

16. The method of claim 12, wherein the first and second communications paths are provided via wireless networks.

17. The method of claim 12 further comprising:
receiving a user selection of one the listed members; and
sending description information associated with the selected member.

18. The method of claim 17, wherein the POI information is selected from the group consisting of a location, a telephone number, an address, a distance from the location of the mobile device, a travel time from the location of the mobile device to the one of the listed members, a cuisine, a review, operating hours, a performance time, a price range, a service offering, an a menu offering.

19. The method of claim 12, wherein creating a list of candidate members of the requested category that are within a first distance of the location of the mobile device comprises:
receiving a list length equal to a preset number of candidate member entries;
determining a count of the candidate member entries; and
when the count of candidate member entries is equal to the list length, then creating the list of candidate members using the candidate member entries.

20. The method of claim 12, wherein creating a list of members of the requested category that are within a first distance of the location of the mobile device comprises:
receiving a list length equal to a preset number of candidate member entries;
determining a count of the candidate member entries; and
when the count of the candidate member entries is greater than the list length then:
grouping the candidate member entries according to an actual distance from the location of the mobile device starting with a most proximate candidate member; and
creating the list of candidate members by selecting a number of entries from the grouping of candidate members starting with the most proximate member equal to the list length.

21. The method of claim 12 further comprising, prior to sending the POI information for each listed candidate member to the mobile device:
receiving a list length equal to a preset number of candidate member entries;
determining a first count of the first candidate member entries;
when the first count of first candidate member entries is less than the list length then:
creating a second list of candidate members of the requested category that are within a second distance from the location of the mobile device, wherein each entry on the second list of candidate members is associated with the first content provider on the second list of content providers to provide such entry;
determining a total count comprising the first count of first candidate member entries plus a second count of second candidate member entries;
when the total count of candidate member entries is equal to the list length, then creating the list of candidate members using the first and second candidate member entries;
when the total count of candidate members is greater than the list length, then:
grouping the first and second candidate member entries according to an actual distance from the location of the mobile device starting with a most proximate candidate member; and
creating the list of candidate members by selecting a number of entries from the grouping of candidate members starting with the most proximate member equal to the list length.

22. (canceled)
